(19) United States
(12) Patent Application Publication
(10) Pub. No.: US 2024/0022376 A1
(43) Pub. Date: Jan. 18, 2024

(54) METHOD AND APPARATUS FOR SL MULTI-BEAM OPERATION

(71) Applicant: Samsung Electronics Co., Ltd., Suwon-si (KR)

(72) Inventors: Emad Nader Farag, Flanders, NJ (US); Eko Onggosanusi, Coppell, TX (US)

(21) Appl. No.: 18/340,688

(22) Filed: Jun. 23, 2023

Related U.S. Application Data
(60) Provisional application No. 63/359,060, filed on Jul. 7, 2022.
(60) Provisional application No. 63/359,074, filed on Jul. 7, 2022.
(60) Provisional application No. 63/457,646, filed on Apr. 6, 2023.

(51) Int. Cl. H04L 5/00; H04W 24/10; H04W 24/08

(52) U.S. Cl. CPC H04L 5/0051; H04W 24/10; H04W 24/08

(57) ABSTRACT

Methods and apparatuses for SL multi-beam operations in a wireless communication system are provided. A method of operating a user equipment (UE) includes transmitting, to a second UE, a sidelink (SL) channel state information-reference signal (CSI-RS) using multiple spatial domain transmit filters and receiving, from the second UE, a first beam measurement report. The method further includes determining, based on the first beam measurement report, a first beam indication and transmitting, based on the determined first beam indication, a first physical SL control channel (PSCCH) or physical SL shared channel (PSSCH).

### CROSS-REFERENCE TO RELATED APPLICATIONS AND CLAIM OF PRIORITY

The present application claims priority to: U.S. Provisional Patent Application No. 63/359,060, filed on Jul. 7, 2022; U.S. Provisional Patent Application No. 63/359,074, filed on Jul. 7, 2022; and U.S. Provisional Patent Application No. 63/457,646, filed on Apr. 6, 2023. The contents of the above-identified patent documents are incorporated herein by reference.

### TECHNICAL FIELD

The present disclosure relates generally to wireless communication systems and, more specifically, the present disclosure relates to a sidelink (SL) multi-beam operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to SL multi-beam operations in a wireless communication system.

In one embodiment, a user equipment (UE) is provided. The UE includes a transceiver configured to transmit, to a second UE, a sidelink (SL) channel state information-reference signal (CSI-RS) using multiple spatial domain transmit filters and receive, from the second UE, a first beam measurement report. The UE further includes a processor operably coupled to the transceiver. The processor is configured to determine, based on the first beam measurement report, a first beam indication. The transceiver is further configured to transmit, based on the determined first beam indication, a first physical SL control channel (PSCCH) or physical SL shared channel (PSSCH).

In another embodiment, a method of operating a UE is provided. The method includes transmitting, to a second UE, a SL CSI-RS using multiple spatial domain transmit filters and receiving, from the second UE, a first beam measurement report. The method further includes determining, based on the first beam measurement report, a first beam indication and transmitting, based on the determined first beam indication, a first PSCCH or PSSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of UE configuration according to embodiments of the present disclosure;

FIGS. 9A to 9C illustrate examples of UE signaling according to embodiments of the present disclosure;

FIGS. 10 to 25 illustrate examples of SL multi-beam operations according to embodiments of the present disclosure; and

FIG. 26 illustrates an example method performed by a UE in a wireless communication system according to embodiments of the present disclosure.

### DETAILED DESCRIPTION

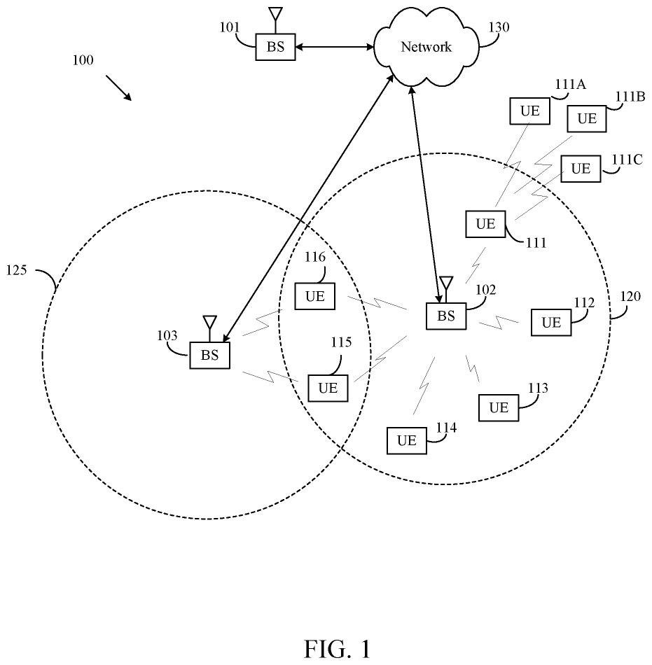

FIG. 1 through FIG. 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.4.0, “NR; Physical channels and modulation”; 3GPP TS 38.212 v17.5.0, “NR; Multiplexing and Channel coding”; 3GPP TS 38.213 v17.5.0, “NR; Physical Layer Procedures for Control”; 3GPP TS 38.214 v17.5.0, “NR; Physical Layer Procedures for Data”; 3GPP TS 38.321 v17.4.0, “NR; Medium Access Control (MAC) protocol specification,” 3GPP TS 38.331 v17.4.0, “NR; Radio Resource Control (RRC) Protocol Specification”; and 3GPP TS 36.213 v17.5.0, “Evolved Universal Terrestrial Radio Access (E-UTRA); Physical layer procedures.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a SL multi-beam operation in a wireless communication system. In certain embodiments, and one or more of the gNBs 101-103 includes circuitry, programing, or a combination thereof, to support a SL multi-beam operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide SL communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

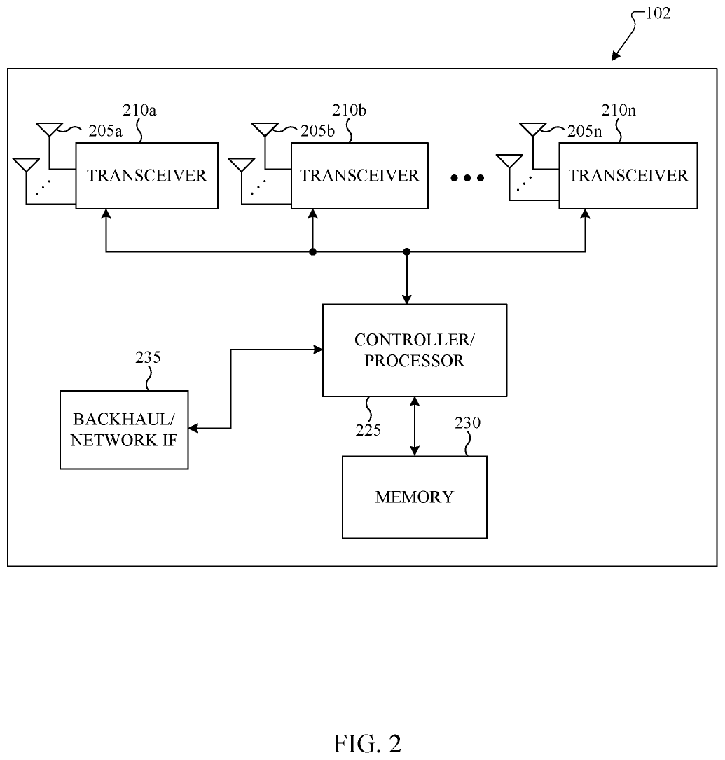

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support or allow for a SL multi-beam operation in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

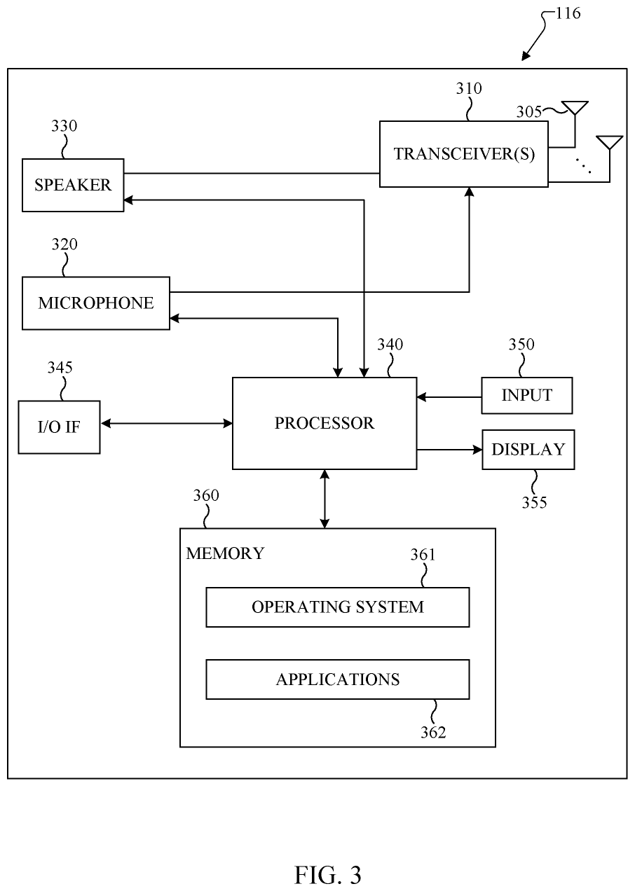

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or channels and/or signals and the transmission of UL and/or channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a SL multi-beam operation in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

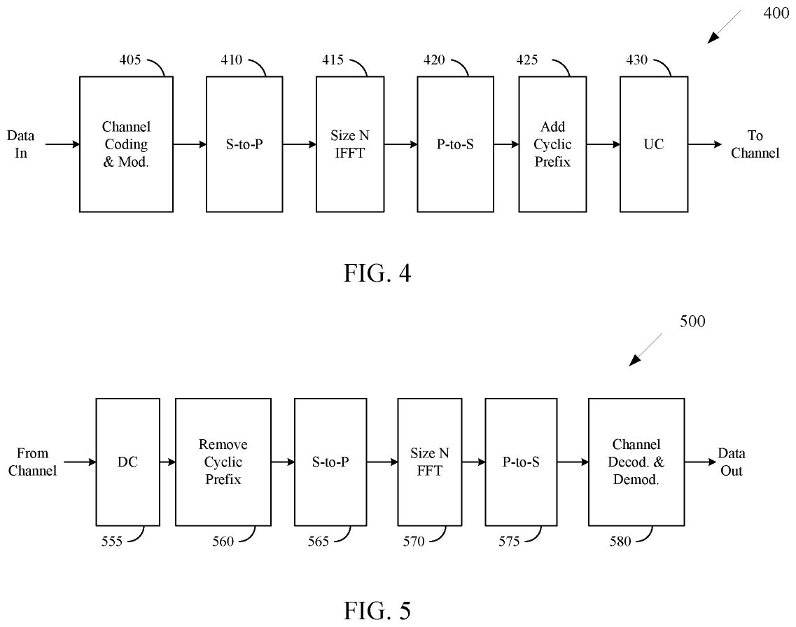

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE (such as a UE 111) and that the transmit path 400 can be implemented in a second UE (such as a UE 111A) to support SL communications. In some embodiments, the receive path 500 is configured to support a SL multi-beam operation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling or SL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems. In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a Transmission Configuration Indication (TCI) state, which establishes a quasi-colocation (QCL) relationship or spatial relationship between a source reference signal (e.g., synchronization signal/physical broadcasting channel (PBCH) block (SSB) and/or channel state information reference signal (CSI-RS)) and a target reference signal; or (2) spatial relation information that establishes an association to a source reference signal, such as SSB or CSI-RS or sounding reference signal (SRS). In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels or signals from the gNB, or a spatial Rx filter for reception of uplink channels or signals at the gNB.

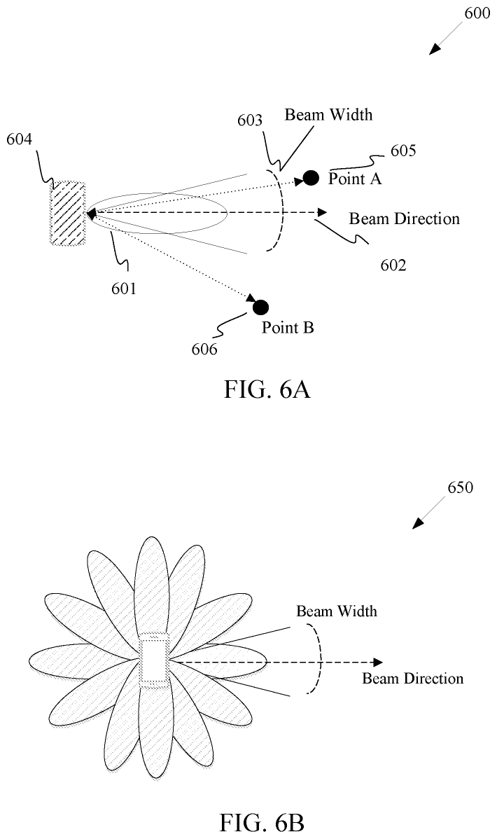

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

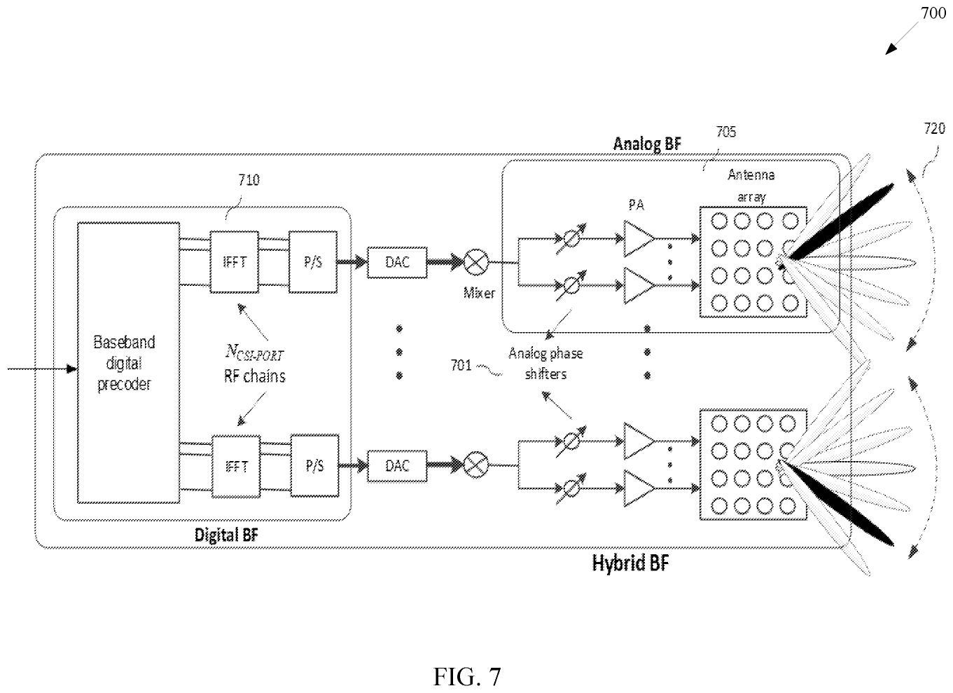

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems. In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization. SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE: (1) HARQ-ACK reporting option 1: a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB, and (2) HARQ-ACK reporting option 2: a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′}_{_{MAX}}₋₁^{SL}} and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·ns_{ubCHsize}+j, where j=0, 1, . . . , ns_{ubCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in TS 38.214 Table 8.1.4-2·T₂ is determined by the UE such that T_{2 min}≤T₂≤Remaining Packet Delay Budget, as long as T_{2 min}<Remaining Packet Delay Budget, else T₂ is equal to the Remaining Packet Delay Budget. T_{2 min} is a configured by higher layers and depends on the priority of the SL transmission.

The slots of a SL resource pool are determined as shown in TABLE 1.

TABLE 1
Slots of s SL resource pool

| 1. | Let set of slots that may belong to a resource be denoted by {t₀^{SL}, t₁^{SL}, t₂^{SL}, ... > t_{T}_{_{MAX}}₋₁^{SL}}, | | |
|---|---|---|---|
| | where 0 ≤ tᵢ^{SL} < 10240 × 2^{μ} , and 0 ≤ i < Tₘₐₓ. μ is the sub-carrier spacing | | |
| | configuration. μ = 0 for a 15 kHz sub-carrier spacing. μ = 1 for a 30 kHz sub-carrier | | |
| | spacing. μ = 2 for a 60 kHz sub-carrier spacing. μ = 3 for a 120 kHz sub-carrier | | |
| | spacing. The slot index is relative to slot#0 of SFN#0 (system frame number 0) of the | | |
| | serving cell, or DFN#0 (direct frame number 0). The set of slots includes all slots except: | | |
| | a. | N_{s-SSB} slots that are configured for SL SS/PBCH Block (S-SSB). | |
| | b. | N_{nonSL} slots where at least one SL symbol is not semi-statically configured as | |
| | | UL symbol by higher layer parameter tdd-UL-DL-ConfigurationCommon or sl- | |
| | | TDD-Configuration. In a SL slot, OFDM symbols Y-th, (Y+1)-th, ... , (Y+X−1)-th | |
| | | are SL symbols, where Y is determined by the higher layer parameter sl-StartSymbol | |
| | | and X is determined by higher layer parameter sl-LengthSymbols. | |
| | c. | N_{reserved} reserved slots. Reserved slots are determined such that the slots in the | |
| | | {t₀SL, t₁SL, t₂SL, ... , t_{T}_{_{MAX}}₋₁^{SL}} is a multiple of the bitmap length (L_{bitmap}), where | |
| | | the bitmap (b₀, b₁, ... , b_{L}_{_{bitmap}}₋₁) is configured by higher layers. The reserved | |
| | | slots are determined as follows: | |
| | | i. | Let {l₀, l₁, ... , l₂_{^{μ}}_{×10240-Ns-SSB-N}_{_{nonSL}}₋₁} be the set of slots in range 0 ... 2^{μ} × |
| | | | 10240 − 1, excluding S-SSB slots and non-SL slots. The slots are |
| | | | arranged in ascending order of the slot index. |
| | | ii. | The number of reserved slots is given by: N_{reserved} = (2^{μ} × 10240 − |
| | | | N_{S-SSB} − N_{nonSL}) mod L_{bitmap}. |
| | | iii. | $The reserved slots {l}_{r} are given by : r = ⌊ \frac{m \cdot ( {2}^{μ} \times 10240 - {N}_{S - SSB} - {N}_{nonSL} )}{{N}_{reserved}} ⌋ ,$ |

where m = 0, 1, ... , N_{reserved} − 1

| | Tₘₐₓ is given by: Tₘₐₓ = 2^{μ} × 10240 − N_{S-SSB} − N_{nonSL} − N_{reserved}. | |
|---|---|---|
| 2. | The slots are arranged in ascending order of slot index. | |
| 3. | The set of slots belonging to the SL resource pool, {t′₀^{SL}, t′₁^{SL}, t′₂^{SL}, ... , t′_{T′}_{_{MAX}}₋₁^{SL}}, are | |
| | determined as follows: | |
| | a. | Each resource pool has a corresponding bitmap (b₀, b₁, ... , b_{L}_{_{bitmap}}₋₁) of length |
| | b. | A slot tₖ^{SL} belongs to the SL resource pool if b_{k mod L}_{_{bitmap}} = 1 |
| | c. | The remaining slots are indexed successively staring from 0, 1, ... T′_{MAX} − 1. |
| | | Where, T′_{MAX} is the number of remaining slots in the set. |

Slots can be numbered (indexed) as physical slots or logical slots, wherein physical slots include all slots numbered sequential, while logical slots include only slots that are allocated to sidelink resource pool as described above numbered sequentially. The conversion from a physical duration, Pᵣₛᵥₚ, in milli-second to logical slots, P′ᵣₛᵥₚ, is given by

$${P}_{rsvp}^{′} = ⌈ \frac{{T}_{max}^{′}}{10240 ms} \times {P}_{rsvp} ⌉$$

(see illustrated in 3GPP standard specification 38.214).

For resource (re-)selection or re-evaluation in slot n, a UE can determine a set of available single-slot resources for transmission within a resource selection window [n+T₁,n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification, TS 38.214 Table 8.1.4-2. T₂ is determined by the UE such that T_{2 min}≤T₂≤Remaining Packet Delay Budget, as long as T_{2 min}<Remaining Packet Delay Budget, else T₂ is equal to the Remaining Packet Delay Budget. T_{2 min} is configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE does not transmit SL. The resources excluded are based on reserved transmissions or semi-persistent transmissions that can collide with the excluded resources or any of reserved or semi-persistent transmissions. The identified candidate resources after resource exclusion are provided to higher layers; and (2) the second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214.

To determine a candidate single-slot resource set to report to higher layers, a UE excludes (e.g., resource exclusion) from the set of available single-slot resources for SL transmission within a resource pool and within a resource selection window, as shown in TABLE 2.

TABLE 2
A determination of a candidate single-slot resource set

| 1. | Single slot resource R_{x,y}, such that for any slot t′ₘ^{SL} not monitored within the sensing | |
|---|---|---|
| | window with a hypothetical received SCI Format 1-0, with a “Resource reservation | |
| | period” set to any periodicity value allowed by a higher layer parameter | |
| | reseverationPeriodAllowed, and indicating all sub-channels of the resource pool in this | |
| | slot, satisfies condition 2.2. below. | |
| 2. | Single slot resource R_{x,y}, such that for any received SCI within the sensing window: | |
| | 1. | The associated L1-RSRP measurement is above a (pre-)configured SL-RSRP |
| | | threshold, where the SL-RSRP threshold depends on the priority indicated in the |
| | | received SCI and that of the SL transmission for which resources are being |
| | | selected. |
| | 2. | (Condition 2.2) The received SCI in slot t′ₘ^{SL}, or if “Resource reservation field” |
| | | is present in the received SCI the same SCI is assumed to be received in slot |
| | | t′_{m+q×P′}_{ᵣₛᵥₚ}_Rx^{SL}, indicates a set of resource blocks that overlaps R_{x,y+j×P′}_{ᵣₛᵥₚ}_Tx. |
| | | Where, |
| | | q = 1,2, ... , Q, where, |
| | | $If {P}_{rsvp \_ RX} \leq {T}_{scal} and {n}^{′} - m < {P}_{rsvp \_ RX}^{′} \to Q = ⌈ \frac{{T}_{scal}}{{P}_{rsvp \_ RX}} ⌉ .$ |
| | | T_{scal} is T₂ in units of milli-seconds. |
| | | Else Q = 1 |
| | | If n belongs to (t′₀^{SL}, t′₁^{SL}, ... , t′_{T′}_{ₘₐₓ}₋₁^{SL}). n′ = n, else n′ is the |
| | | first slot after slot n belonging to set (t′₀^{SL}, t′₁^{SL}, ... , t′_{T′}_{ₘₐₓ}₋₁^{SL} |
| | | j = 0, 1, ... , Cᵣₑₛₑₗ − 1 |
| | | Pᵣₛᵥₚ_RX is the indicated resource reservation period in the received SCI |
| | | in physical slots, and P′ᵣₛᵥₚ_RX is that value converted to logical slots. |
| | | P′ᵣₛᵥₚ_TX is the resource reservation period of the SL transmissions for |
| | | which resources are being reserved in logical slots. |
| | 3. | If the candidate resources are less than a (pre-)configured percentage given by higher |
| | | layer parameter sl_TxPrecentageList(prio_{TX}) that depends on the priority of the SL |
| | | transmission priorx, such as 20%, of the total available resources within the resource |
| | | selection window, the (pre-)configured SL-RSRP thresholds are increased by a |
| | | predetermined amount, such as 3 dB. |

An NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T′₃.

The re-evaluation check includes: (1) performing the first step of the SL resource selection procedure as defined in the 3GPP specifications (e.g., 3GPP standard specification 38.214), which involves identifying a candidate (available) sidelink resource set in a resource selection window as previously described; (2) if the pre-selected resource is available in the candidate sidelink resource set, the resource is used/signaled for sidelink transmission; and (3) else, the pre-selected resource is not available in the candidate sidelink resource set, a new sidelink resource is re-selected from the candidate sidelink resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃. When pre-emption check is enabled by higher layers, pre-emption check includes: (1) performing the first step of the SL resource selection procedure as defined in the 3GPP standard specification 38.214, which involves identifying candidate (available) sidelink resource set in a resource selection window as previously described; (2) if the pre-selected and reserved resource is available in the candidate sidelink resource set, the resource is used/signaled for sidelink transmission; and (3) else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}: (i) if the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority, and (ii) else, the resource is used/signaled for sidelink transmission.

As described above, the monitoring procedure for resource (re)selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The aforementioned sensing procedure is referred to a full sensing.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement.” The objectives of Rel-17 SL include: (1) Resource allocation enhancements that reduce power consumption. (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′y-k×Pᵣₑₛₑᵣᵥₑ^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes all periodicities in sl-ResourceReservePeriodList.

The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensing Occasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. A UE-A provides information to a UE-B, and the UE-B uses the provided information for its resource allocation mode 2 (re-)selection procedure. IUC is designed to address issues with distributed resource allocation such as: (1) Hidden node problem, where the UE-B is transmitting to the UE-A and the UE-B cannot sense or detect transmissions from a UE-C that interfere with a transmission to the UE-A, (2) Exposed node problem, where a UE-B is transmitting to the UE-A, and the UE-B senses or detects transmissions from a UE-C and avoids the resources used or reserved by the UE-C, but the UE-C does not cause interference at the UE-A, (3) Persistent collision problem, and (4) Half-duplex problem, where the UE-B is transmitting to the UE-A in the same slot that the UE-A is transmitting in, the UE-A may miss the transmission from the UE-B as the UE-A cannot receive and transmit in the same slot.

There are two schemes for inter-UE co-ordination as shown in following examples.

In one example, in scheme 1, a UE-A can provide to another UE-B indications of resources that are preferred to be included in the UE-B's (re-)selected resources, or non-preferred resources to be excluded for the UE-B's (re-)selected resources. When given preferred resources, the UE-B may use only those resources for its resource (re-)selection, or the UE-B may combine them with resources identified by its own sensing procedure, e.g., by finding the intersection of the two sets of resources, for its resource (re-)selection. When given non-preferred resources, the UE-B may exclude these resources from resources identified by its own sensing procedure for its resource (re-)selection.

Transmissions of co-ordination information (e.g., IUC messages) sent by the UE-A to the UE-B, and co-ordination information requests (e.g., IUC requests) sent by the UE-A to the UE-B, are sent in a MAC-CE message and may also, if supported by the UEs, be sent in a 2^{nd}-stage SCI Format (SCI Format 2-C). The benefit of using the 2nd stage SCI is to reduce latency. IUC messages from the UE-A to the UE-B can be sent standalone, or can be combined with other SL data. Coordination information (IUC messages) can be in response to a request from the UE-B, or due to a condition at the UE-A. An IUC request is unicast from the UE-B to the UE-A, in response the UE-A sends an IUC message in unicast mode to the UE-B. An IUC message transmitted as a result of an internal condition at the UE-A can be unicast to the UE-B, when the IUC message includes preferred resources, or can be unicast, groupcast or broadcast to the UE-B when the IUC message includes non-preferred resources. The UE-A can determine preferred or non-preferred resources for the UE-B based on the UE-A's own sensing taking into account the SL-RSRP measurement of the sensed data and the priority of the sensed data, i.e., the priority field of the decoded PSCCH during sensing as well as the priority the traffic transmitted by the UE-B in case of request-based IUC or a configured priority in case of condition-based IUC. Non-preferred resource to the UE-B can also be determined to avoid the half-duplex problem, where the UE-A cannot receive data from the UE-B in the same slot the UE-A is transmitting.

In another example, in scheme 2, a UE-A can provide to another UE-B an indication that resources reserved for the UE-B's transmission, whether or not the UE-A is the destination UE of these resources, are subject to conflict with a transmission from another UE. The UE-A determines the conflicting resources based on the priority and RSRP of the transmissions involved in the conflict. The UE-A can also determine a presence of a conflict due to the half-duplex problem, where the UE-A cannot receive a reserved resource from the UE-B at the same time the UE-A is transmitting. When the UE-B receives a conflict indication for a reserved resource, the UE-B can re-select new resources to replace them.

The conflict information from the UE-A is sent in a PSFCH channel separately (pre-)configured from the PSFCH of the SL-HARQ operation. The timing of the PSFCH channel carrying conflict information can be based on the SCI indicating reserved resource, or based on the reserved resource.

In both schemes, the UE-A can identify resources according to a number of conditions which are based on the SL-RSRP of the resources in question as a function of the traffic priority, and/or whether the UE-A may be unable to receive a transmission from the UE-B, due to performing the UE-A's own transmission, i.e., a half-duplex problem. The purpose of this exchange of information is to give the UE-B information about resource occupancy acquired by the UE-A which the UE-B may not be able to determine on the UE-B's own due to hidden nodes, exposed nodes, persistent collisions, etc.

Release 18 considers further evolution of the NR SL air interface for operation in unlicensed bands, beam-based operation in FR2, SL carrier aggregation and co-channel co-existence between LTE SL and NR SL.

On the Uu interface a beam is determined by either of: (1) a TCI state, that establishes a quasi-colocation (QCL) relationship or spatial relation between a source reference signal (e.g., SSB and/or CSI-RS) and a target reference signal; or (2) a spatial relation information that establishes an association to a source reference signal, such as SSB or CSI-RS or SRS. In either case, the ID of the source reference signal identifies the beam.

Terminology such as TCI, TCI states, SpatialRelationInfo, target RS, reference RS, and other terms is used for illustrative purposes and is therefore not normative. Other terms that refer to same functions can also be used.

Rel-17 introduced the unified TCI framework, where a unified or master or main or indicated TCI state is signaled or indicated to the UE. The unified or master or main or indicated TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; and (3) in case of separate TCI state indication, wherein different beams are used for DL and UL channels, a UL TCI state that can be used at least for UE-dedicated UL channels.

The unified (master or main or indicated) TCI state is a DL or a Joint TCI state of UE-dedicated reception on PDSCH/PDCCH and the CSI-RS applying the indicated TCI state and/or an UL or a Joint TCI state for dynamic-grant/configured-grant based PUSCH, PUCCH, and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels can be received and/or transmitted using a TCI state associated with a cell having a PCI different from the PCI of the serving cell. While the common channels can be received and/or transmitted using a TCI state associated with the serving cell (e.g., not associated with a cell having a PCI different from the PCI of the serving cell).

Common channels can include: (1) channels carrying system information (e.g., system information block 1 (SIB1)) with a DL assignment carried by a DCI in PDCCH having a CRC scrambled by SI-RNTI and transmitted in Type0-PDCCH CSS set; (2) channels carrying other system information with a DL assignment carried by a DCI in PDCCH having a CRC scrambled by SI-RNTI and transmitted in Type0A-PDCCH CSS set; (3) channels carrying paging or short messages with a DL assignment carried by a DCI in PDCCH having a CRC scrambled by P-RNTI and transmitted in Type2-PDCCH CSS set; and/or (4) channels carrying RACH related channels with a DL assignment or UL grant carried by a DCI in PDCCH having a CRC scrambled by RA-RNTI or TC-RNTI and transmitted in Type1-PDCCH CSS set.

A DL-related DCI Format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

Quasi-co-location (QCL) relation, can be quasi-location with respect to one or more of the following relations (e.g., 3GPP standard specification 38.214): (1) Type A, {Doppler shift, Doppler spread, average delay, delay spread}; (2) Type B, {Doppler shift, Doppler spread}; (3) Type C, {Doppler shift, average delay}; and (4) Type D, {Spatial Rx parameter}.

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

A “reference RS” corresponds to a set of characteristics of a DL beam or an UL TX beam, such as a direction, a precoding/beamforming, a number of ports, and so on.

On a Uu interface, a TCI state can be used for beam indication. A TCI state can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be a gNB or UE panel specific or common across panels. In some examples, the uplink TCI state can be replaced by SRS resource indicator (SRI).

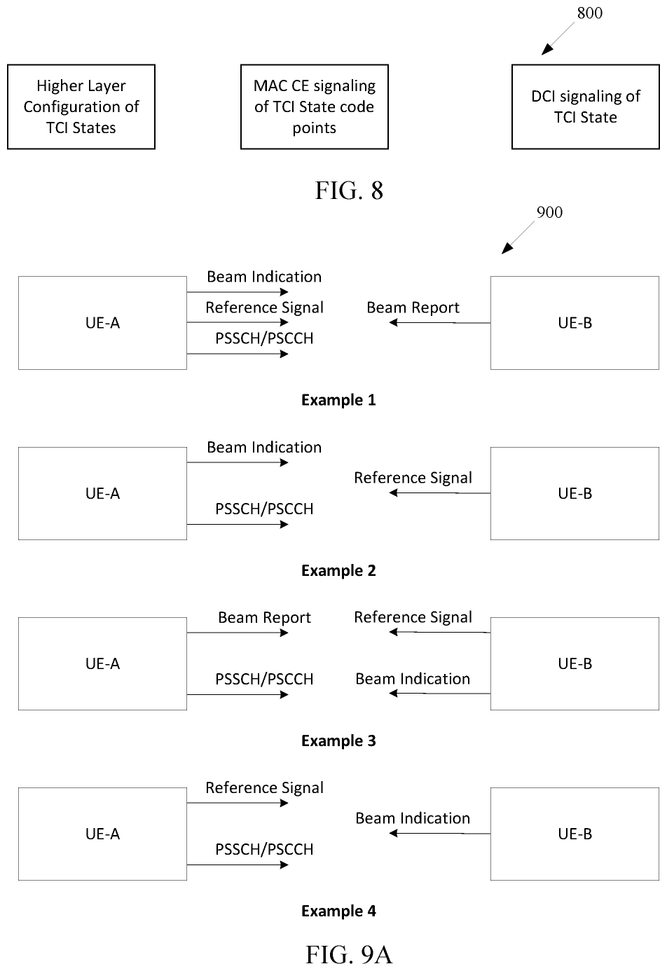

FIG. 8 illustrates an example of UE configuration 800 according to embodiments of the present disclosure. An embodiment of the UE configuration 800 shown in FIG. 8 is for illustration only.

A UE can be configured/updated through higher layer RRC signaling (as illustrated in FIG. 8) a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}. N, the total number of configured TCI states, can be given by: N=N_{DJ}+N_{U}. The DLorJoint-TCIState can include DL or Joint TCI states that belong to a serving cell, e.g., the source RS of the TCI state is associated with the serving cell (the PCI of the serving cell), additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell), additionally, the UL TCI states can be associated with a cell having a PCI different from the PCI of the serving cell, e.g., the source RS of the TCI state is associated with a cell having a PCI different from the PCI of the serving cell.

A MAC CE signaling (as illustrated in FIG. 8) includes activating a subset of M (M≤N) TCI states or TCI state code points from the set of N TCI states, wherein a code point is signaled in the “transmission configuration indication” field of a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., downlink control information (DCI)) updates the UE's TCI state, wherein the DCI includes a “transmission configuration indication” (beam indication) field e.g., with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The present disclosure provides beam management for SL in FR2. The following aspects are considered: (1) triggering the beam management procedure (e.g., the transmission of the reference signal used for beam management); (2) transmission of reference signal to measure the channel and determine or refine beams; (3) beam measurement and reporting; and 4) beam indication and application to a SL transmission.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement” (RP-201385). Release 18 considers further evolution of the NR SL air interface for operation in unlicensed bands, beam-based operation in FR2, SL carrier aggregation and co-channel co-existence between LTE SL and NR SL. One of the key features of NR is its ability to support beam-based operation. This is especially important for operation in FR2 which suffers a higher propagation loss. In Rel-16 and Rel-17 the main focus of developing SL was FR1. Indeed, the frequency bands supported for SL in Rel-16 and Rel-17 are all sub-6 GHz frequencies (bands n14, n38, n47, and n79). One of the objectives of Rel-18 is to expand SL to FR2, while SL supports SL phase tracking reference signal (PTRS), an important feature to support operation in FR2, i.e., beam management, is missing. In this disclosure, some aspects related to beam management are provided: (1) Triggering the beam management procedure (e.g., the transmission of the reference signal used for beam management). (2) Transmission of reference signal to measure the channel and determine or refine beams. (3) Beam measurement and reporting. (4) Beam indication and application to a SL transmission.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. It is noted that a first UE is referred as a UE-A and a second UE as a UE-B. In one example, a UE-A is transmitting SL data on PSSCH/PSCCH, and the UE-B is receiving the SL data on PSSCH/PSCCH.

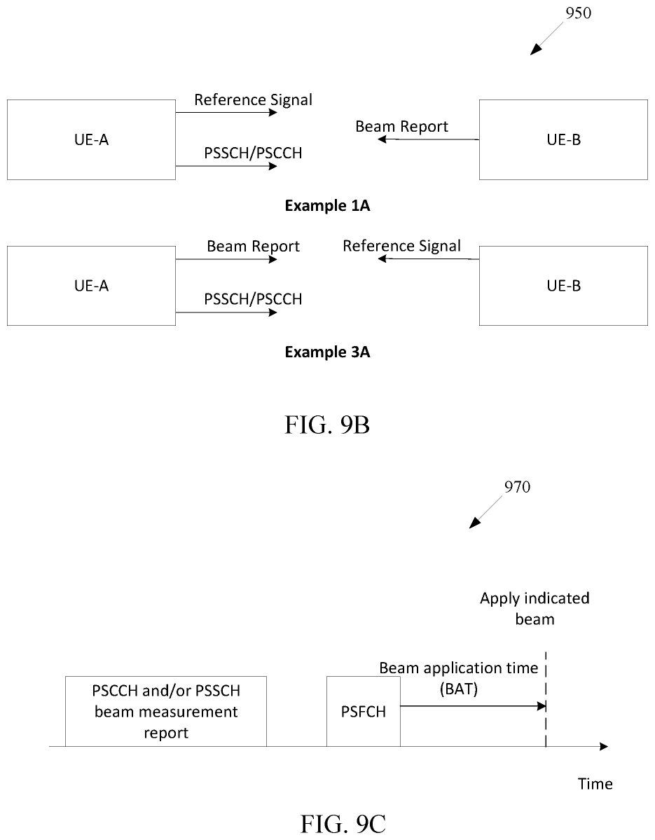

FIGS. 9A to 9C illustrate examples of UE signaling 900, 950, and 970 according to embodiments of the present disclosure. The UE signaling 900, 950, and 970 as may be performed by a UE (e.g., 111-116 as illustrated in FIG. 1). An embodiment of the UE signaling 900, 950, and 970 shown in FIGS. 9A to 9C is for illustration only. One or more of the components illustrated in FIGS. 9A to 9C can be implemented in specialized circuitry configured to perform the noted functions or one or more of the components can be implemented by one or more processors executing instructions to perform the noted functions.

For mmWave bands (or FR2) or for higher frequency bands (such as >52.6 GHz) where multi-beam operation is especially relevant, a transmission-reception process includes a receiver in a second UE (e.g., a UE-B) selecting a receive (RX) beam for a given TX beam from a first UE (e.g., a UE-A). The selection of the Rx beam can be based on measurements at the UE-B's decision or based on beam indication from a UE-A as aforementioned in the examples of FIGS. 9A to 9C. The UE-A and the UE-B may or may not be in coverage of a network.

In the present disclosure a beam is also referred to a spatial domain filter. For example, a transmit beam is a spatial domain transmission (or transmit) filter, and a receive beam is a spatial domain reception (or receive) filter.

In the present disclosure, an RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In the present disclosure MAC CE signaling includes: (1) MAC CE signaling over the Uu interface, and/or (2) MAC CE signaling over the PC5 or SL interface.

In the present disclosure L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In the present disclosure, a beam report or beam measurement report can be (1) a periodic report, e.g., preconfigured or configured by higher layers, (2) a semi-persistent report that is activated and/or deactivated by MAC CE signaling and/or L1 control signaling, or (3) aperiodic report that triggered by L1 control signaling and/or MAC CE signaling.

In the present disclosure, the container of the beam report (or beam measurement report) can be: (1) a MAC CE report, for example MAC CE report can reuse the MAC CE CSI report on the SL PC5 interface; (2) an SCI report container, the SCI report container can be first stage SCI (e.g., conveyed by PSCCH) and/or a second stage SCI (e.g., conveyed by PSSCH). In one example, the second stage SCI is a standalone second stage SCI in PSSCH, with no sidelink shared channel (SL-SCH) in PSSCH. In another example, the second stage SCI is multiplexed in PSSCH with a MAC CE carrying the beam report (or beam measurement report) with no other SL data. In another example, the second stage SCI is multiplexed in PSSCH with a MAC CE carrying the beam report (or beam measurement report) and other SL data. In another example, the second stage SCI is multiplexed in PSSCH with other SL data e.g., in a SL-SCH; (3) a PSFCH report container, in one example, the PSFCH can be redesigned to carry more than one bit of information, e.g., a PSFCH with N bits of information and N>1. In one example, a beam report (or beam measurement report) is one bit, for example, indicating if a beam is good (e.g., valid) or bad (e.g., invalid). In one example, a beam report (or beam measurement report) is N bits, with N being a small number and N PSFCHs are used; and (4) if a UE is in network coverage, the beam report (or beam measurement report) can be sent to the network using UCI on PUCCH or PUSCH and/or the beam report (or beam measurement report) can be sent to the network using MAC CE on the Uu interface.

In the present disclosure, a beam can be identified for communication between a first UE and a second UE. In one example for the first UE, a same beam is used to transmit PSSCH/PSCCH and PSFCH from the first UE to the second UE. In one example, for the first UE, a same beam is used to receive PSSCH/PSCCH and PSFCH at the first UE from the second UE. In one example for the first UE, different beams are used to transmit PSSCH/PSCCH and PSFCH from the first UE to the second UE. In one example, for the first UE, different beams are used to receive PSSCH/PSCCH and PSFCH at the first UE from the second UE. In one example for the first UE, different beams are used to transmit PSSCH and PSCCH from the first UE to the second UE. In one example, for the first UE, different beams are used to receive PSSCH and PSCCH at the first UE from the second UE. The roles of the first and second UEs can be interchanged.

In one example, a UE can have beam correspondence, without beam sweeping, between the transmit beam and receive beam, for example, if the transmit beam to a second UE is known, the receive beam from the second UE is also known without beam sweeping. In one example, a UE can have beam correspondence, without beam sweeping, between the transmit beam and receive beam, for example, if the receive beam from a second UE is known, the transmit beam to the second UE is also known without beam sweeping. In one example, a UE performs beam sweeping to determine a receive beam from a second UE, regardless of whether or not the UE knows a transmit beam to the second UE. In one example, a UE performs beam sweeping to determine a transmit beam to a second UE, regardless of whether or not the UE knows a receive beam from the second UE.

In one example (e.g., Example 1 of FIG. 9A), a reference RS can be transmitted by a UE-A and can be received and measured by a UE-B (for example, the reference RS can be a SL signal such as SL NZP CSI-RS and/or SL SSB and/or SL SRS transmitted by a UE-A). The UE-B can use the result of the measurement for calculating a beam report (e.g., a SL beam report), the beam report can include, for example, at least one L1-RSRP accompanied by at least one reference RS index/ID, henceforth referred to as a beam-ID-metric pair. Using the received beam report, a UE-A can assign (or select) a particular SL TX beam to a transmission to the UE-B and indicates the beam to the UE-B. The UE-B receives a reference RS index/ID, for example through a field in a SCI format (first stage SCI carried on PSCCH or second stage SCI carried on PSSCH), this represents a beam (e.g., a TCI state or a spatial relation). In one example, the beam indication (e.g., reference RS index/ID) can be included in the PSSCH/PSCCH transmission from a UE-A to the UE-B to which the beam indication can apply. In another example, the beam indication (e.g., reference RS index/ID) can be in a separate transmission from a UE-A to the UE-B. The UE-B applies the known characteristics of the reference signal to the associated SL reception (PSSCH/PSCCH).

A SL SRS is a SL sounding reference signal that can be transmitted by a SL UE. In one example, the SL SRS sequence can follow the sequence design of UL SRS, e.g., using a Zadoff-Chu sequence, the UL SRS is described in TS 38.211. A S-SSB is a SL synchronization signal block that includes a (1) S-PSS (SL primary synchronization reference signal); (2) S-SSS (SL secondary synchronization reference signal); and (3) PSBCH (physical SL broadcast channel), the S-SSB can be as described in TS 38.211. In one example, an S-SSB can include and/or indicate a UE-ID. In one example, an S-SSB can include and/or indicate a beam ID. A SL NZP CSI-RS is a SL channels state information reference signal; the SL CSI-RS can be as described in TS 38.211. In one example, the NZP-CSI-RS can be transmitted with PSSCH/PSCCH, in another example, the NZP-CSI-RS can be transmitted in a standalone transmission. In one example, a CSI-RS can include and/or indicate a UE-ID. In one example, a CSI-RS can include and/or indicate a beam ID.

In Example 1 of FIG. 9A, a UE-B selects a SL RX beam for every SL TX beam from a UE-A (that corresponds to a reference RS). Therefore, when SL RS, is used as reference RS, the UE-A transmits the SL RS to the UE-B for the UE-B to be able to select a SL Rx beam, the SL Rx beam is for the UE-B. In one example, the UE-B triggers or configures a UE-A to transmit the SL RS. In another example a UE-A triggers or configures the transmission of SL RS from the UE-A. In response, the UE-B measures the SL RS (transmitted by the UE-A), and in the process selects a SL RX beam (to be used by the UE-B), and reports the SL beam metric associated with the quality of the SL RS. In this case, the UE-B determines the TX-RX beam pair for every configured SL reference RS transmitted by a UE-A. Therefore, although this knowledge is unavailable to the UE-A, the UE-B, upon receiving a SL RS index/ID associated with a SL TX beam indication from the UE-A, the UE-B can select the SL RX beam.

In a variant of Example 1 of FIG. 9A, as illustrated in Example 1A of FIG. 9B, there is no beam indication from a UE-A to a UE-B, instead the beam included in the beam measurement report from the UE-B to the UE-A is used as the beam for SL transmission from the UE-A to the UE-B. A beam in a beam measurement report can be referred to by the ID or index of a reference RS. In one example, the beam measurement report includes one beam ID-metric-pair, wherein the included beam in the beam measurement report from the UE-B to a UE-A is the beam used for the SL transmission from the UE-A to the UE-B, i.e., the spatial transmission filter associated with a reference RS ID associated with the beam ID-metric-pair of the beam measurement report is the spatial domain transmission filter used for the SL transmission from the UE-A.

In one example, the beam measurement report includes more than one beam ID-metric-pair, wherein the beam with best (e.g., highest) metric in the beam measurement report from a UE-B to a UE-A is the beam used for the SL transmission from the UE-A to the UE-B, i.e., the spatial transmission filter associated with a reference RS ID associated with the beam ID-metric-pair, with the best metric, of the beam measurement report is the spatial domain transmission filter used for the SL transmission from the UE-A.

In one example, the beam measurement report includes more than one beam ID-metric-pair e.g., M beams, the beams are indexed in the beam measurement report from by index m, wherein m=0, 1, . . . , M−1, wherein the beam with index mb in the beam measurement report from a UE-B to a UE-A is the beam used for the SL transmission from the UE-A to the UE-B, i.e., the spatial transmission filter associated with a reference RS ID associated with the beam ID-metric-pair, with index mb, of the beam measurement report is the spatial domain transmission filter used for the SL transmission from the UE-A. In one example mb=0. In another example mb=M−1. In one example, M can be specified in system specifications and/or pre-configured and/or configured or update by RRC signaling and/or MAC CE signaling and/or L1 control (e.g., SCI or DCI).

In another example, mb can be indicated in the beam measurement report. In another example mb can be indicated in a different message than the beam measurement report. In another example mb can be specified in system specifications and/or pre-configured and/or configured or update by RRC signaling and/or MAC CE signaling and/or L1 control (e.g., SCI or DCI). The indicated beam in the beam measurement report is applied after a beam application time. In one example, the beam application time is from the end or the start of the beam measurement report (e.g., the PSCCH/PSSCH transmission that includes the beam measurement report). In another example, the beam application time is from the end or the start of the acknowledgement to the beam measurement report (e.g., the PSFCH including an acknowledgement to the beam measurement report), this example is illustrated in FIG. 9C. In one example, the beam application time can be specified in system specifications and/or pre-configured and/or configured or update by RRC signaling and/or MAC CE signaling and/or L1 control (e.g., SCI or DCI).

In another example (e.g., Example 2 of FIG. 9A), a reference RS can be transmitted by a UE-B and can be received and measured by a UE-A (for example, the reference RS can be a SL signal such as SL NZP CSI-RS and/or SL SSB and/or SL SRS transmitted by the UE-B). As a UE-A receives and measures the reference RS from the UE-B, the UE-A can measure and calculate information used to assign (or select) a particular SL TX beam to a transmission to the UE-B. The UE-A indicates the beam to the UE-B. The UE-B receives a reference RS index/ID, for example through a field in a SCI format (first stage SCI carried on PSCCH or second stage SCI carried on PSSCH), this represents a beam (e.g., a TCI state or a spatial relation). The beam indication (e.g., reference RS index/ID) can be included in the PSSCH/PSCCH transmission or can be in a separate transmission from the UE-A to the UE-B. The UE-B applies the known characteristics of the reference sign to the associated SL reception (PSSCH/PSCCH). This option is applicable at least when there is SL Rx-Tx beam pair correspondence, for example by knowing the Rx beam for transmissions from a UE the Tx beam for transmissions to the same UE can be determined or by knowing the Tx beam for transmissions to a UE the Rx beam for transmissions from the same UE can be determined.

In Example 2 of FIG. 9A, a SL RS transmitted from a UE-B to a UE-A is used as reference RS, at least when RX-TX beam correspondence or reciprocity holds. In one example, a UE-A can trigger or configure the UE-B to transmit the SL RS. In another example, the UE-B triggers or configures the SL RS transmission. By reciprocity, the SL RS transmitted from the UE-B corresponds to a SL Rx beam at the UE-B. The UE-A, upon receiving and measuring the SL RS from the UE-B, can select a SL TX beam for a transmission from the UE-A. As a result, a TX-RX beam pair is derived. The UE-A can perform this operation for all the configured SL RSs transmitted from the UE-B, either per reference RS or by “beam sweeping,” and determine all TX-RX beam pairs associated with all the SL RSs configured for the UE-B to transmit on.

In another example (e.g., Example 3 of FIG. 9A), a reference RS can be transmitted by a UE-B and can be received and measured by the UE-A (for example, the reference RS can be a SL signal such as SL NZP CSI-RS and/or SL SSB and/or SL SRS transmitted by the UE-B) and the UE-A can use the result of the measurement to calculate a beam report (e.g., a SL beam report), the beam report can include, for example, at least one L1-RSRP accompanied by at least one reference RS index/ID (e.g., a beam-ID-metric pair). The UE-A transmits the SL beam report to the UE-B. The UE-B can use the beam report to assign (or select) a particular SL TX beam for a transmission from the UE-A and indicates such beam to the UE-A. The UE-A can receive a reference RS index/ID, for example through a field in a SCI format (first stage SCI carried on PSCCH or second stage SCI carried on PSSCH) this represents a beam (e.g., a TCI state or a spatial relation).

In one example, the beam indication (e.g., reference RS index/ID) can be included in a first SL transmission from the UE-B to the UE-A scheduling a second SL transmission from the UE-A to the UE-B to which the beam indication applies. In another example, the beam indication (e.g., reference RS index/ID) can be included in a SL transmission from the UE-B to the UE-A. The UE-A then applies the known characteristics of the reference RS to the SL transmission from the UE-A to the UE-B. This option is applicable at least when there is SL Rx-Tx beam pair correspondence, for example by knowing the Rx beam for transmissions from a UE the Tx beam for transmissions to the same UE can be determined or by knowing the Tx beam for transmissions to a UE the Rx beam for transmissions from the same UE can be determined.

In Example 3 of FIG. 9A, a SL RS can be transmitted by a UE-B and is used as a reference RS, this case applies at least when there is Rx-Tx beam correspondence or reciprocity. The SL RS transmitted from the UE-B is received and measured by a UE-A. By reciprocity, the SL RS transmitted from the UE-B corresponds to a SL Rx beam at the UE-B. In one example, the UE-A can trigger or configure the UE-B to transmit the SL RS. In another example, the UE-B triggers or configures the SL RS transmission. In response, the UE-A measures the reference RS (and in the process selects a SL TX beam for transmission from the UE-A) and reports the beam metric associated with the quality of the reference RS to the UE-B. In this case, the UE-A determines the TX-RX beam pair for every configured SL reference RS from the UE-B. Therefore, although this information is unavailable at the UE-B, when the UE-A receives a reference RS index/ID (hence an SL RX beam at the UE-B by reciprocity), the UE-A can select a SL TX beam for transmission to the UE-B.

In a variant of Example 3 of FIG. 9A, as illustrated in Example 3A of FIG. 9B, there is no beam indication from a UE-B to a UE-A, instead the beam included in the beam measurement from the UE-A to the UE-B is used as the beam for SL transmission from the UE-A to the UE-B. A beam in a beam measurement report can be referred to by the ID or index of a reference RS. In one example, the beam measurement report includes one beam ID-metric-pair, wherein the included beam in the beam measurement report from the UE-A to the UE-B is the beam used for the SL transmission from the UE-A to the UE-B, i.e., the spatial transmission filter associated with a reference RS ID associated with the beam ID-metric-pair of the beam measurement report determines the spatial domain transmission filter (by reciprocity or beam correspondence) used for the SL transmission from the UE-A.

In one example, the beam measurement report includes more than one beam ID-metric-pair, wherein the beam with best (e.g., highest) metric in the beam measurement report from the UE-A to the UE-B is the beam used for the SL transmission from the UE-A to the UE-B, i.e., the spatial transmission filter associated with a reference RS ID associated with the beam ID-metric-pair, with the best metric, of the beam measurement report determines the spatial domain transmission filter (by reciprocity or beam correspondence) used for the SL transmission from the UE-A.

In one example, the beam measurement report includes more than one beam ID-metric-pair e.g., M beams, the beams are indexed in the beam measurement report from by index m, wherein m=0, 1, . . . , M−1, wherein the beam with index mb in the beam measurement report from a UE-A to a UE-B is the beam used for the SL transmission from the UE-A to the UE-B, i.e., the spatial transmission filter associated with a reference RS ID associated with the beam ID-metric-pair, with index mb, of the beam measurement report determines the spatial domain transmission filter (by reciprocity or beam correspondence) used for the SL transmission from the UE-A. In one example mb=0. In another example mb=M−1. In one example, M can be specified in system specifications and/or pre-configured and/or configured or update by RRC signaling and/or MAC CE signaling and/or L1 control (e.g., SCI or DCI).

In another example, m_{b} can be indicated in the beam measurement report. In another example m_{b} can be indicated in a different message than the beam measurement report. In another example m_{b} can be specified in system specifications and/or pre-configured and/or configured or update by RRC signaling and/or MAC CE signaling and/or L1 control (e.g., SCI or DCI). The indicated beam in the beam measurement report is applied after a beam application time. In one example, the beam application time is from the end or the start of the beam measurement report (e.g., the PSCCH/PSSCH transmission that includes the beam measurement report). In another example, the beam application time is from the end or the start of the acknowledgement to the beam measurement report (e.g., the PSFCH including an acknowledgement to the beam measurement report), this example is illustrated in FIG. 9C. In one example, the beam application time can be specified in system specifications and/or pre-configured and/or configured or update by RRC signaling and/or MAC CE signaling and/or L1 control (e.g., SCI or DCI).

In another example (Example 4 of FIG. 9A), a reference RS can be transmitted by a UE-A and can be received and measured by a UE-B (for example, the reference RS can be a SL signal such as SL NZP CSI-RS and/or SL SSB and/or SL SRS transmitted by the UE-B). The UE-B can use the received reference RS to measure and calculate information that the UE-B can use to assign (or select) a particular SL TX beam to a transmission from the UE-A to the UE-B and indicates such beam to the UE-A. The UE-A can receive a reference RS index/ID, for example through a field in a SCI format (first stage SCI carried on PSCCH or second stage SCI carried on PSSCH) this represents a beam (e.g., a TCI state or a spatial relation). In one example, the beam indication (e.g., reference RS index/ID) can be included in a first SL transmission from a UE-B to a UE-A scheduling a second SL transmission from the UE-A to the UE-B to which the beam indication applies. In another example, the beam indication (e.g., reference RS index/ID) can be included in a SL transmission from the UE-B to the UE-A. The UE-A then applies the known characteristics of the reference RS to the SL transmission from the UE-A to the UE-B.

In Example 4 of FIG. 9A, a UE-B selects a SL RX beam to be used at the UE-B for every SL TX beam from the UE-A that corresponds to a reference RS. A SL RS transmitted from the UE-A is associated with a SL TX beam from the UE-A. In one example, a UE-B triggers or configures a UE-A to transmit the SL RS. In another example, a UE-A triggers or configures the transmission of SL RS from the UE-A. A UE-B, upon receiving and measuring the SL RS transmitted by the UE-A, selects a SL RX beam at the UE-B. As a result, a TX-RX beam pair is derived for a transmission from the UE-A to the UE-B. The UE-B can perform this operation for all the configured reference RSs transmitted by the UE-A, either per reference RS or by “beam sweeping,” and determine all the TX-RX beam pairs associated with all the reference RSs configured for the UE-A to transmit on.

For example, 1 to example 4 in FIG. 9A, one or more of the following example can be applied.

In one example, the reference RS can be triggered by (e.g., by a SCI format, for example a first stage SCI carried on PSCCH, or a second stage SCI carried on PSSCH) either from a UE-A or from a UE-B. This, for example, can be in case of aperiodic reference RS. This can be an example of event-driven event, UE-initiated, either at a UE-A or a UE-B. For example, a UE-A, i.e., the UE transmitting the SL transmission determines (e.g., based on an event) that a new beam may be used and triggers or indicates or requests the transmission of the reference RS either from the UE-A or from the UE-B. In another example, a UE-B, i.e., the UE receiving the SL transmission determines (e.g., based on an event) that a new beam may be used and triggers or indicates or requests the transmission of the reference RS either from the UE-A or from the UE-B.

In one example, when a UE-A and/or a UE-B is in coverage of the network, the reference RS can be triggered by a DCI format from the network sent to the UE-A and/or the UE-B. This, for example, can be in case of aperiodic reference RS. In one example, a UE-A transmitting the SL transmission and/or a UE-B receiving the SL transmission determines (e.g., based on an event) that a new beam may be used and can send an indication to network (e.g., using PUCCH or PUSCH) to trigger the transmission of reference RS either from the UE-A or the UE-B.

In one example, the reference RS can be configured with a certain time domain behavior, such a periodicity and/or an offset. The configuration can be by a UE-A and/or a UE-B, e.g., through PC5 RRC signaling. This, for example, can be in case example in case of periodic reference RS. In one example, the periodicity and/or offset can be specified in system specifications and/or pre-configured and/or configured or update by RRC signaling and/or MAC CE signaling and/or L1 control (e.g., SCI or DCI).

In one example, when a UE-A and/or a UE-B is in coverage of the network, the reference RS can be configured with a certain time domain behavior, such a periodicity and/or an offset. The configuration can be by the network, e.g., through RRC signaling. This, for example, can be in case example in case of periodic reference RS.

In one example, in addition to RRC configuration, the transmission of the reference signal can be activated or deactivated, by a UE-A and/or a UE-B and/or the network (when the UE-A and/or the UE-B is in network coverage). In one example, the entity (e.g., a UE-A or a UE-B or the network) configuring the reference RS is the same as the entity activating/deactivating the reference RS. In another example, the entity configuring the reference RS can be different from the entity activating/deactivating the reference RS. This, for example, can be in case example in case of semi-persistent reference RS.

As illustrated in FIGS. 9A to 9C, a multi-beam operation includes the following examples of steps.

In one example of step of configuration, and activation/deactivation and/or triggering of reference RS, this can be performed by a UE-A and/or a UE-B and/or a gNB/network (when the UE-A and/or the UE-B) is in coverage of the network. In one example, the UE operates in mode 2 resource allocation and UE preforms sensing and resource exclusion to find and select a SL resource for transmission of the trigger or indication or request signal. The UE may further preform re-evaluation check or pre-emption check on the selected SL resource before the transmission of the trigger or indication or request signal.

In one example of step of transmission of reference RS, this can be performed by a UE-A (examples 1 and 4 of FIG. 9A), or by a UE-B (examples 2 and 3 of FIG. 9A). In one example, the UE operates in mode 2 resource allocation and UE preforms sensing and resource exclusion to find and select a SL resource for transmission of the reference RS. The UE may further preform re-evaluation check or pre-emption check on the selected SL resource before the transmission of the reference RS. In one example, the trigger or indication signal and the reference RS are included in the same SL transmission. In another example, the trigger or indication or request signal and the reference RS are included different SL transmissions. In one example, the UE sending a trigger or indication or request signal for transmission of reference RS may indicate resources to be used for the transmission of the reference RS.

In one example of reference RS measurement and beam reporting if applicable, the reference RS is measured by an entity different from the entity transmitting the reference RS. The reference RS can be measured by a UE-A (examples 2 and 3 of FIG. 9A) or by a UE-B (examples 1 and 4 of FIG. 9A). The beam report can be sent by one entity to another entity that determines the beam. Beam report can be sent by the UE-B (example 1 of FIG. 9A), or by the UE-A (example 3 of FIG. 9A). If the UE determining the beam is the same as the UE measuring the reference RS, there is no beam report (example 2 and 4 of FIG. 9A). In one example, the UE operates in mode 2 resource allocation and UE preforms sensing and resource exclusion to find and select a SL resource for transmission of the SL beam measurement report. The UE may further preform re-evaluation check or pre-emption check on the selected SL resource before the transmission of the SL beam measurement report. In one example, the UE sending a trigger or indication or request signal for transmission of reference RS may indicate resources to be used for the transmission of the SL beam measurement report. In one example, the UE sending a reference RS may indicate resources to be used for the transmission of the SL beam measurement report.

In one example of step of beam selection and beam indication, a beam indication can be sent by a UE-A (examples 1 and 2 of FIG. 9A) or by a UE-B (examples 3 and 4 of FIG. 9A). In one example, the UE operates in mode 2 resource allocation and UE preforms sensing and resource exclusion to find and select a SL resource for transmission of the SL beam indication. The UE may further preform re-evaluation check or pre-emption check on the selected SL resource before the transmission of the SL beam indication. In one example, the UE sending a trigger or indication or request signal for transmission of reference RS may indicate resources to be used for the transmission of the SL beam indication. In one example, the UE sending a reference RS may indicate resources to be used for the transmission of the SL beam indication. In one example, the UE sending a SL beam measurement report may indicate resources to be used for the transmission of the SL beam indication. In one example, the SL beam indication is included with other SL data transmission, wherein the SL beam indication is not applied to the included SL data. In one example, the SL beam indication is included with other SL data transmission, wherein the SL beam indication is applied to the included SL data.

In one example of step, transmission and reception of the SL transmission using the selected beam is provided.

In one example, the beam management procedure can be triggered or started or initiated by the UE transmitting the SL data. In another, example the beam management procedure can be triggered or started or initiated by the UE receiving the SL data.

In one example, for a pair of UEs, e.g., a UE-A and a UE-B, when the UE-A transmits on the SL to the UE-B and the UE-B transmits on the SL to the UE-A, a same beam pair can be found for SL transmission from the UE-A to the UE-B and for SL transmission from the UE-B to the UE-A, in this example a same reference signal ID or index can be used to identify such beam pair, a single beam management procedure can be triggered to find such beam pair, this can apply to the case of beam reciprocity or beam correspondence at the UE-A and the UE-B.

In another example, for a pair of UEs, e.g., a UE-A and a UE-B, when the UE-A transmits on the SL to the UE-B and the UE-B transmits on the SL to the UE-A, a different beam pairs can be found for SL transmission from the UE-A to the UE-B and for SL transmission from the UE-B to the UE-A, in this example a first reference signal ID or index can be used to identify a first beam pair for SL transmission from the UE-A to the UE-B and a second, a second reference signal ID or index can be used to identify a second beam pair for SL transmission from the UE-A to the UE-B. A first beam management procedure can be triggered to find the first reference signal ID (or first beam pair), a second beam management procedure can be triggered to find the second reference signal ID (or second beam pair). This can apply to the case of no beam reciprocity, or no beam correspondence at the UE-A and/or the UE-B, or the to the case of beam reciprocity or beam correspondence at the UE-A and the UE-B.

It is noted that that in addition to the above, a third UE, e.g., a UE-C can be involved in the beam management procedure. For example, a UE-C can configure, activate/deactivate and/or trigger the beam management procedure and the transmission of reference signals for channel sounding for beam management. The third UE can also receive the beam measurement report and make a decision on which beams to use and send this decision to a UE-A and/or a UE-B. TABLE 3 summarizes the various options of the steps of multi-beam operation.

TABLE 3
Multi-beam operation steps

| | Entity | | | | Transmission |
|---|---|---|---|---|---|
| | configuring or | | | Entity | and reception |
| | activating or | | | performing | of SL |
| | deactivating or | Entity | Entity reporting | beam selection | transmission |
| Example# from | triggering | transmitting | SL beam | and beam | (PSSCH/ |
| FIG. 9A | reference RS | reference RS | measurement | indication | PSCCH) |
| Example 1 | UE-A and/or | UE-A | UE-B | UE-A | Tx: UE-A |
| | UE-B and/or | | | | Rx: UE-B |
| | gNB (network) | | | | |
| Example 2 | UE-A and/or | UE-B | N/A. | UE-A | Tx: UE-A |
| | UE-B and/or | | No measurement | | Rx: UE-B |
| | gNB (network) | | report | | |
| | | | measurement | | |
| | | | performed at | | |
| | | | UE-A | | |
| Example 3 | UE-A and/or | UE-B | UE-A | UE-B | Tx: UE-A |
| | UE-B and/or | | | | Rx: UE-B |
| | gNB (network) | | | | |
| Example 4 | UE-A and/or | UE-A | N/A. | UE-B | Tx: UE-A |
| | UE-B and/or | | No measurement | | Rx: UE-B |
| | gNB (network) | | report | | |
| | | | measurement | | |
| | | | performed at | | |
| | | | UE-B | | |

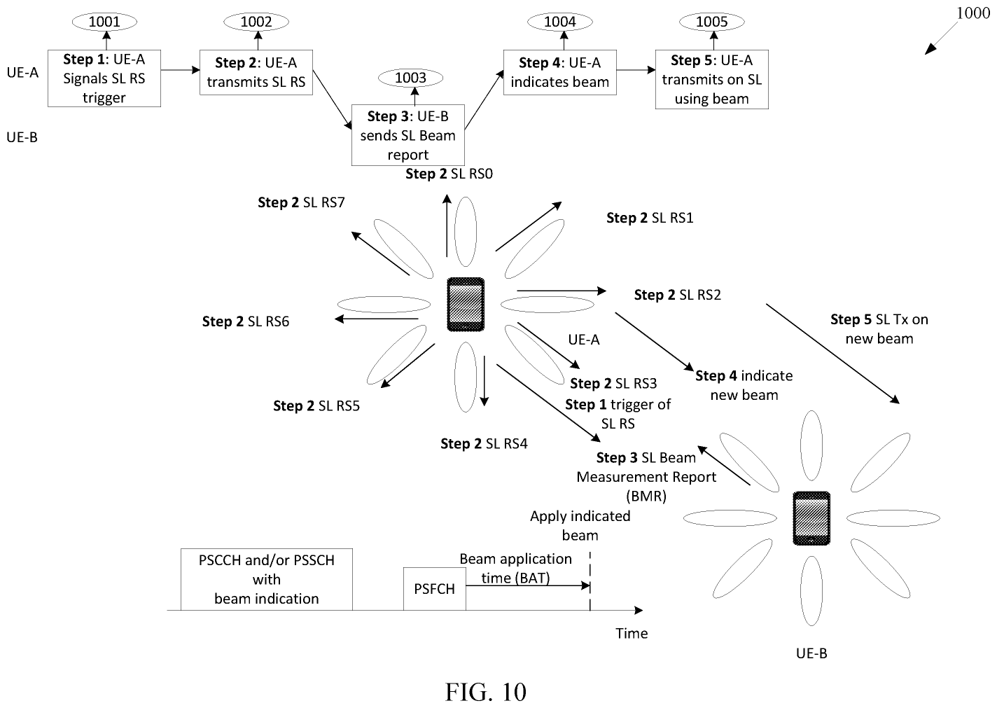

FIGS. 10 to 25 illustrate examples of SL multi-beam operations according to embodiments of the present disclosure. The SL multi-beam operations as may be performed by a UE (e.g., 111-116 as illustrated in FIG. 1) and a BS (e.g., 101-103 as illustrated in FIG. 1). An embodiment of the SL multi-beam operations shown in FIGS. 10 to 25 are for illustration only. One or more of the components illustrated in FIGS. 10 to 25 can be implemented in specialized circuitry configured to perform the noted functions or one or more of the components can be implemented by one or more processors executing instructions to perform the noted functions.

In one example, a SL multi-beam operation starts with a UE-A signaling to a UE-B an aperiodic SL RS (e.g., SL CSI-RS or SL SRS) trigger or indication (step 1001). In FIG. 10, the trigger or indication of SL RS is shown to be transmitted on one beam (spatial transmission filter) from the UE-A, in another example, the trigger or indication of SL RS can be transmitted on multiple beams (or spatial transmission filter) from a UE-A. This trigger or indication can be included in a SCI Format (first stage SCI carried on PSCCH or second stage SCI carried on PSSCH) and/or in a transmission on PSSCH and/or PSFCH and/or in a MAC CE and/or in an RRC message (e.g., PC5 RRC).

In one example the trigger or indication can indicate transmission of SL RS in a same (zero time offset) or in a later slot/sub-frame (>0 time offset). In one example, the SCI can be related to scheduling of SL data and SL RS can be included in a same SL transmission as the SL data. In another example, the SCI can be related to scheduling of SL data, but the SL RS can be included in a SL transmissions separate from the SL transmission used for SL data. In another example, the SCI is used for triggering SL RS transmission, and there is no SL data. In another example, the SL RS trigger can be jointly or separately coded with a SL beam measurement report trigger. A UE-A transmits an aperiodic SL RS to the UE-B in step 1002. In FIG. 10, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 1002), the UE-B measures the AP-SL-RS and calculates and reports a “beam metric” that indicates a quality of one or more UE-A SL TX beam hypothesis (step 1003). Examples of such beam reporting are a SL RS resource indicator coupled with an associated L1-SL-RSRP/L1-SL-RSRQ/L1-SL-SINR/SL-CQI.

Upon receiving the beam report from the UE-B, the UE-A can use the beam report to select a SL RX beam for the UE-B to receive on and indicate the SL RX beam (for the UE-B) selection (step 1004) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. The UE-B selects its SL RX beam and performs SL reception, such as a PSSCH/PSCCH reception, using the SL RX beam associated with the reference RS (step 1005). In one example, the application of the indicated beam can be after beam application delay from the SL transmission conveying the beam indication or from the acknowledgment of the SL transmission conveying the beam indication.

In a variant, there is no beam indication, instead a beam is determined based on the beam measurement report as aforementioned in Example 1A of FIG. 9B.

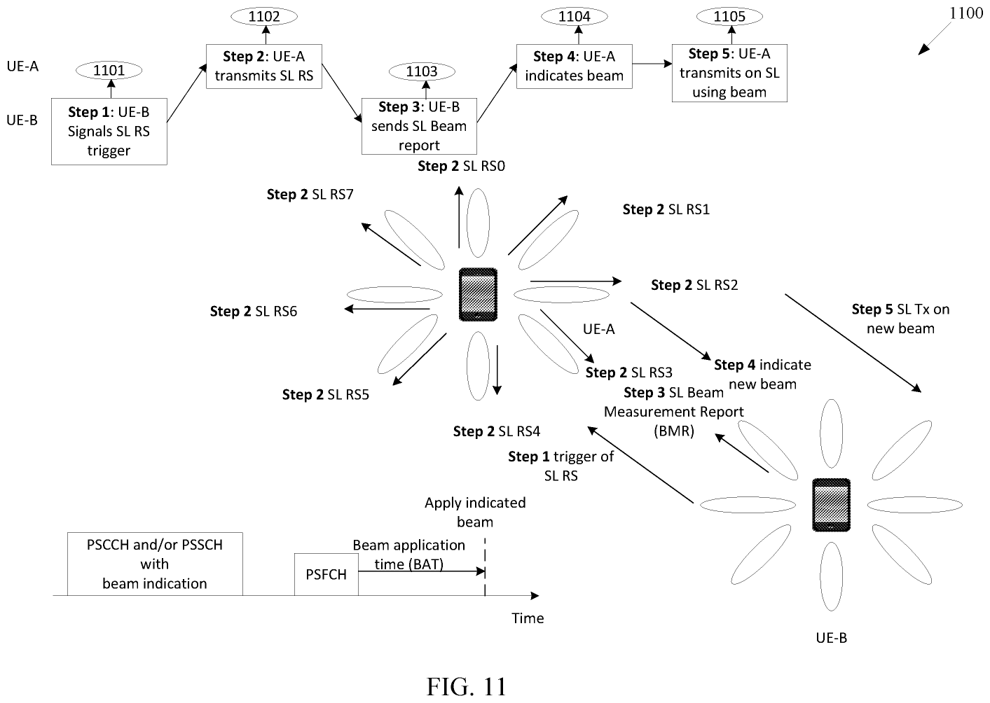

In one example, a SL multi-beam operation starts with a UE-B signaling to a UE-A an aperiodic SL RS (e.g., SL CSI-RS or SL SRS) trigger or request (step 1101). In one example, the trigger or request for the SL RS includes a slot offset for a slot for the SL RS transmission. This trigger or indication can be included in a SCI Format (first stage SCI carried on PSCCH or second stage SCI carried on PSSCH) and/or in a transmission on PSSCH and/or PSFCH and/or in a MAC CE and/or in an RRC message (e.g., PC5 RRC). In FIG. 11, the trigger or request of SL RS is shown to be transmitted on one beam (spatial transmission filter) from the UE-B, in another example, the trigger or request of SL RS can be transmitted on multiple beams (or spatial transmission filter) from the UE-B. Upon receiving and decoding the SL RS trigger or request (e.g., in an SCI Format) in step 1101, the UE-A transmits an aperiodic SL RS to the UE-B in step 1102. In FIG. 11, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 1102), the UE-B measures the AP-SL-RS and calculates and reports a “beam metric” that indicates a quality of one or more UE-A SL TX beam hypothesis (step 1103). Examples of such beam reporting are a SL RS resource indicator coupled with an associated L1-SL-RSRP/L1-SL-RSRQ/L1-SL-SINR/SL-CQI.

Upon receiving the beam report from the UE-B, the UE-A can use the beam report to select a SL RX beam for the UE-B to receive on and indicate the SL RX beam (for the UE-B) selection (step 1104) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. The UE-B selects its SL RX beam and performs SL reception, such as a PSSCH/PSCCH reception, using the SL RX beam associated with the reference RS (step 1105). In one example, the application of the indicated beam can be after beam application delay from the SL transmission conveying the beam indication or from the acknowledgment of the SL transmission conveying the beam indication.

In a variant, there is no beam indication, instead a beam is determined based on the beam measurement report as aforementioned in Example 1A of FIG. 9B.

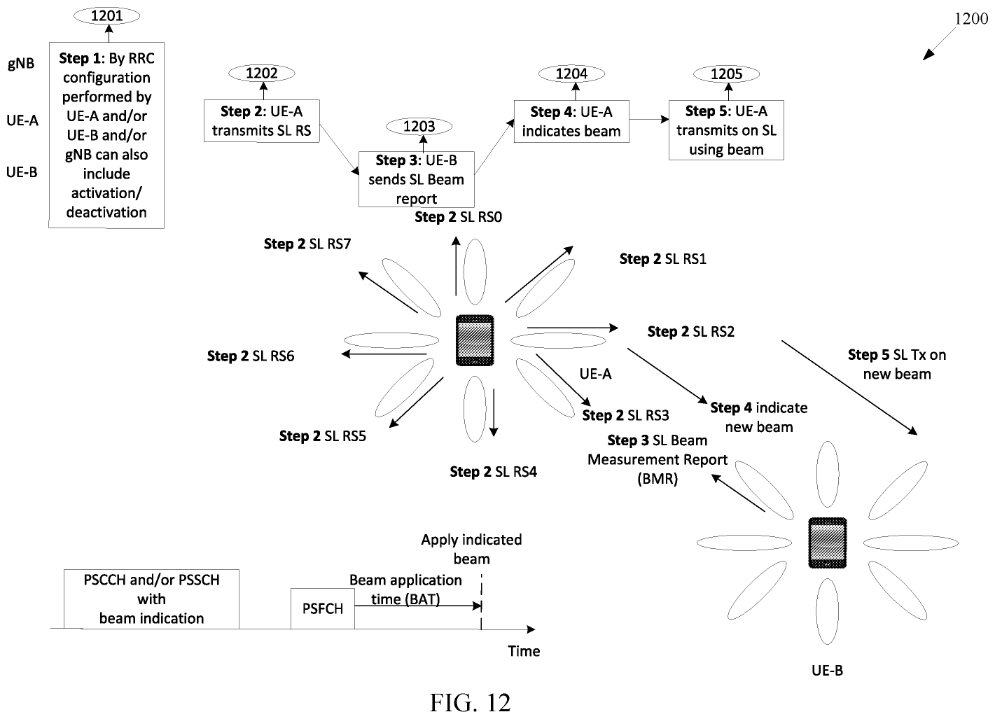

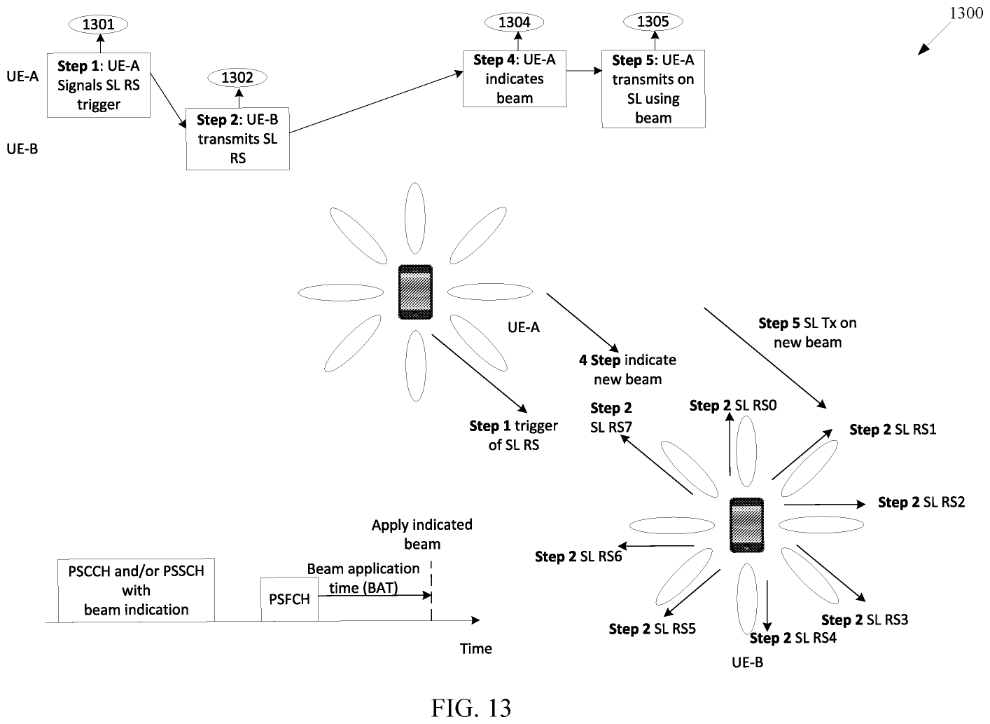

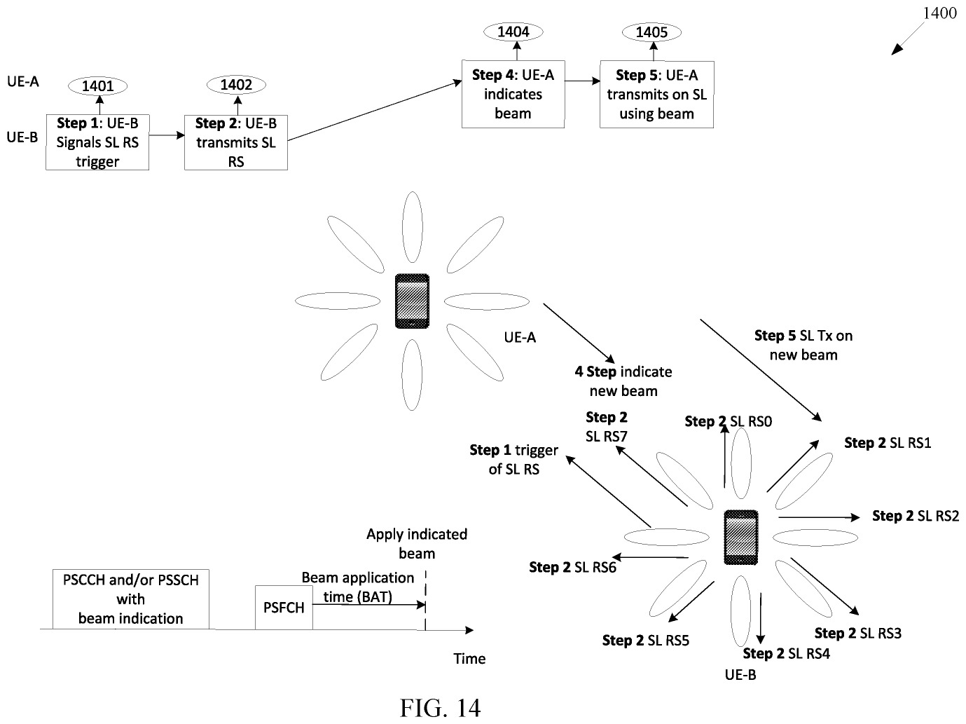

In one example, a SL multi-beam operation starts with RRC configuration of SL RS resources for beam measurement. The configuration (step 1201) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1201, the UE-A transmits a periodic or semi-persistent SL RS to the UE-B in step 1202. In FIG. 12, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-A (step 1202), the UE-B measures the SL-RS and calculates and reports a “beam metric” that indicates a quality of one or more UE-A SL TX beam hypothesis (step 1203). Examples of such beam reporting are a SL RS resource indicator coupled with an associated L1-SL-RSRP/L1-SL-RSRQ/L1-SL-SINR/SL-CQI.

Upon receiving the beam report from the UE-B, the UE-A can use the beam report to select a SL RX beam for the UE-B to receive on and indicate the SL RX beam (for the UE-B) selection (step 1204) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. A UE-B selects its SL RX beam and performs SL reception, such as a PSSCH/PSCCH reception, using the SL RX beam associated with the reference RS (step 1205). In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

In a variant, there is no beam indication, instead a beam is determined based on the beam measurement report as aforementioned in Example 1A of FIG. 9B.

For Example 1 of FIG. 9A, as described above, a UE-B selects its SL RX beam using an index of a reference RS, such as a SL-CSI-RS or SL-SRS, that is provided via beam indication field, for example in a SCI format (first stage SCI carried on PSCCH or second stage SCI carried on PSSCH) from a UE-B. In this case, SL RS resources transmitted by a UE-A are configured to the UE-A and the UE-B as the reference RS resources and can be linked to (associated with) a “beam metric” reporting such as L1-SL-RSRP/L1-SL-RSRQ/L1-SL-SINR/SL-CQI. The UE-A measures the reference RS transmitted from the UE-B to determine the SL RX beam (spatial receive filter) at the UE-A and indicate the reference RS to the UE-B.

In one example, SL multi-beam operation starts with a UE-A signaling to a UE-B an aperiodic SL RS (e.g., SL CSI-RS or SL SRS) trigger or request (step 1301). In one example, the trigger or request for the SL RS includes a slot offset for a slot for the SL RS transmission. In FIG. 13, the trigger or request of SL RS is shown to be transmitted on one beam (spatial transmission filter) from the UE-A, in another example, the trigger or request of SL RS can be transmitted on multiple beams (or spatial transmission filter) from the UE-A. This trigger or request can be included in a SCI Format (first stage SCI carried on PSCCH or second stage SCI carried on PSSCH) and/or in a transmission on PSSCH and/or PSFCH and/or in a MAC CE and/or in an RRC message (e.g., PC5 RRC). Upon receiving and decoding the SL-RS trigger or request (e.g., in an SCI Format) in step 1301, the UE-B transmits an aperiodic SL RS to the UE-A in step 1302. Each RS reference can be associated with a SL TX beam from the UE-B. In FIG. 13 the SL RS is shown to be transmitted on multiple beams (spatial transmission filters) from the UE-B. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-B (step 1302), the UE-A measures the SL propagation channel from the UE-B to the UE-A. In this example, there is no reporting of beam measurements as the UE-A already has the measurements. The UE-A selects a SL RX beam at the UE-A for every SL TX beam from the UE-B that corresponds to a reference RS. As a result, a TX-RX beam pair is derived from the UE-B to the UE-A. By reciprocity (beam correspondence) the UE-A can select a SL-TX beam corresponding to SL-RX beam at the UE-A, and the UE-B, when indicated a reference signal, can select a SL-RX beam at the UE-B corresponding to the SL-TX beam at the UE-B associated with the reference signal. Hence, the TX-RX pair is derived for a SL transmission from the UE-A to the UE-B.

As aforementioned, the UE-A can use the SL measurement to select a SL RX beam for the UE-B to receive on and indicate the SL RX beam (for the UE-B) selection (step 1304) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. A UE-B selects its SL RX beam and performs SL reception, such as a PSSCH/PSCCH reception, using the SL RX beam associated with the reference RS (step 1305) as aforementioned. In one example, the application of the indicated beam can be after beam application delay from the SL transmission conveying the beam indication or from the acknowledgment of the SL transmission conveying the beam indication.

In one example, SL multi-beam operation starts with a UE-B signaling or indicating to a UE-A an aperiodic SL RS (e.g., SL CSI-RS or SL SRS) trigger or indication (step 1401). In FIG. 14, the trigger or indication of SL RS is shown to be transmitted on one beam (spatial transmission filter) from the UE-B, in another example, the trigger or indication of SL RS can be transmitted on multiple beams (or spatial transmission filter) from the UE-A. This trigger or indication can be included in a SCI Format (first stage SCI carried on PSCCH or second stage SCI carried on PSSCH) and/or in a transmission on PSSCH and/or PSFCH and/or in a MAC CE and/or in an RRC message (e.g., PC5 RRC). In one example the trigger or indication can indicate transmission of SL RS in a same (zero time offset) or in a later slot/sub-frame (>0 time offset). The UE-B transmits an aperiodic SL RS to the UE-A in step 1402. Each RS reference can be associated with a SL TX beam from the UE-B. In FIG. 14, the SL RS is shown to be transmitted on multiple beams (spatial transmission filters) from the UE-B. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-B (step 1402), the UE-A measures the SL propagation channel from the UE-B to the UE-A. In this example, there is no reporting of beam measurements as the UE-A already has the measurements. The UE-A selects a SL RX beam at the UE-A for every SL TX beam from the UE-B that corresponds to a reference RS. As a result, a TX-RX beam pair is derived from the UE-B to the UE-A. By reciprocity (beam correspondence) the UE-A can select a SL-TX beam corresponding to SL-RX beam at the UE-A, and the UE-B, when indicated a reference signal, can select a SL-RX beam at the UE-B corresponding to the SL-TX beam at the UE-B associated with the reference signal. Hence, the TX-RX pair is derived for a SL transmission from the UE-A to the UE-B.

As aforementioned, the UE-A can use the SL measurement to select a SL RX beam for the UE-B to receive on and indicate the SL RX beam (for the UE-B) selection (step 1404) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. A UE-B selects its SL RX beam and performs SL reception, such as a PSSCH/PSCCH reception, using the SL RX beam associated with the reference RS (step 1405) as aforementioned. In one example, the application of the indicated beam can be after beam application delay from the SL transmission conveying the beam indication or from the acknowledgment of the SL transmission conveying the beam indication.

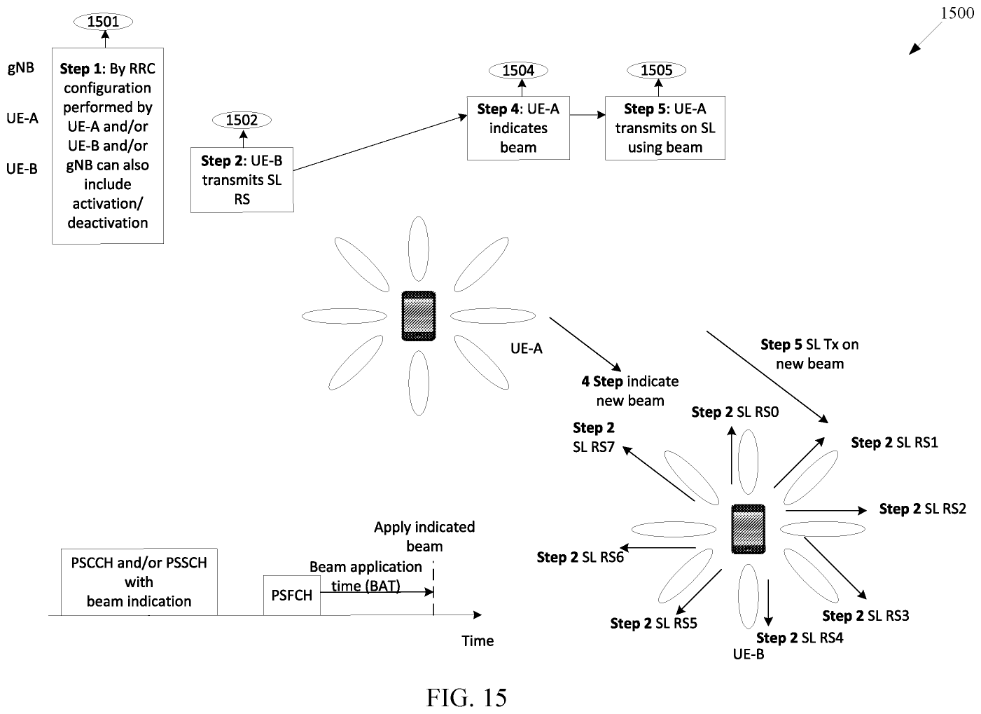

In one example, SL multi-beam operation starts with RRC configuration of SL RS resources for beam measurement. The configuration (step 1501) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1501, the UE-B transmits a periodic or semi-persistent SL RS to the UE-A in step 1502. Each RS reference can be associated with a SL TX beam from the UE-B. In FIG. 15, the SL RS is shown to be transmitted on multiple beams (spatial transmission filters) from the UE-B. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-B (step 1502), the UE-A measures the SL propagation channel from the UE-B to the UE-A. In this example, there is no reporting of beam measurements as the UE-A already has the measurements. The UE-A selects a SL RX beam at the UE-A for every SL TX beam from the UE-B that corresponds to a reference RS. As a result, a TX-RX beam pair is derived from the UE-B to the UE-A. By reciprocity (beam correspondence) the UE-A can select a SL-TX beam corresponding to SL-RX beam at the UE-A, and the UE-B, when indicated a reference signal, can select a SL-RX beam at the UE-B corresponding to the SL-TX beam at the UE-B associated with the reference signal. Hence, the TX-RX pair is derived for a SL transmission from the UE-A to the UE-B.

As aforementioned, the UE-A can use the SL measurement to select a SL RX beam for the UE-B to receive on and indicate the SL RX beam (for the UE-B) selection (step 1504) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. The UE-B selects its SL RX beam and performs SL reception, such as a PSSCH/PSCCH reception, using the SL RX beam associated with the reference RS (step 1505) as aforementioned. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

For Example 2 of FIG. 9A, as described above, a UE-B selects its SL RX beam using an index of a reference RS, such as a SL-CSI-RS or SL-SRS, that is provided via beam indication field, for example in a SCI format (first stage SCI carried on PSCCH or second stage SCI carried on PSSCH). In this case, SL RS resources transmitted by the UE-B are configured to a UE-A and the UE-B as the reference RS resources and by reciprocity, (beam correspondence), the UE-B can determine a spatial RX filter corresponding to the spatial TX filter associated with the reference RS indicated by the UE-A. Similarly, the UE-A selected a spatial TX filter corresponding to the spatial RX filter associated with the reference RS at the UE-A.

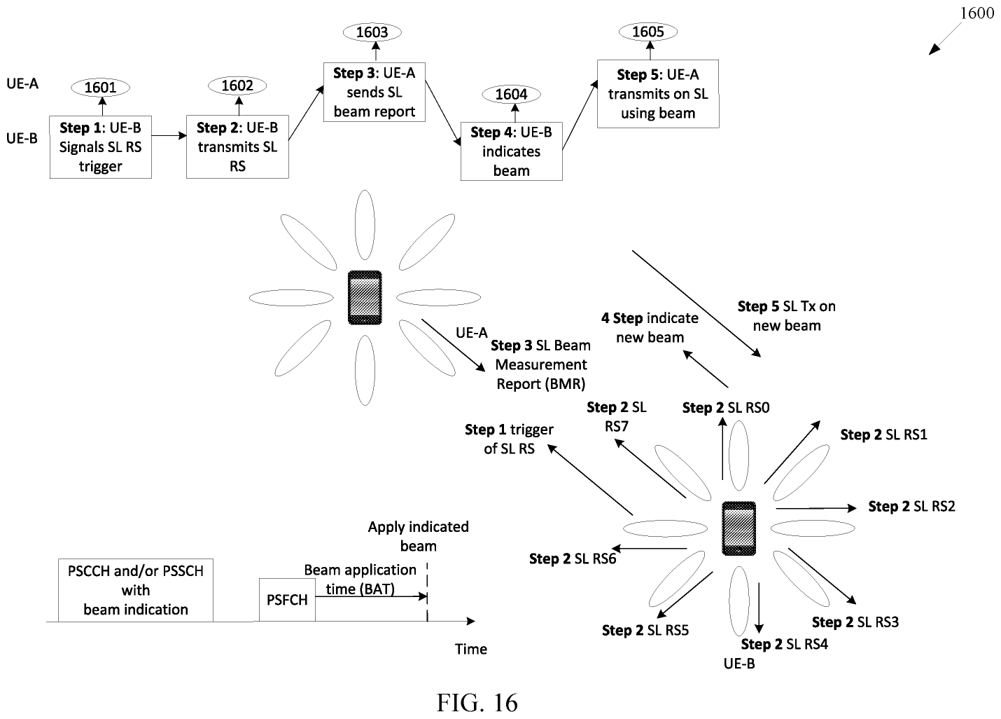

In one example, SL multi-beam operation starts with a UE-B signaling to a UE-A an aperiodic SL-RS (e.g., SL CSI-RS or SL SRS) trigger or indication (step 1601). In one example, the trigger or request for the SL RS includes a slot offset for a slot for the SL RS transmission. In FIG. 16, the trigger or indication of SL RS is shown to be transmitted on one beam (spatial transmission filter) from the UE-B, in another example, the trigger or indication of SL RS can be transmitted on multiple beams (or spatial transmission filters) from the UE-B. This trigger or indication can be included in a SCI format (first stage SCI carried on PSCCH or second stage SCI carried on PSSCH), and/or in a transmission on PSSCH and/or PSFCH and/or in a MAC CE and/or in an RRC message (e.g., PC5 RRC). In one example the trigger or indication can indicate transmission of SL RS in a same slot (zero time offset) or in a later slot/sub-frame (>0 time offset). In one example, the SL RS trigger can be jointly or separately coded with a SL beam measurement report trigger. A UE-B transmits an aperiodic SL RS to a UE-A in step 1602. In FIG. 16, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL-RS transmitted by the UE-B (step 1602), the UE-A measures the AP-SL-RS (SL propagation channel from the UE-B to the UE-A) and, in turn, calculates and reports a “beam metric” that indicates a quality of one or more UE-B SL TX beam hypothesis (step 1603). Examples of such beam reporting are SL RS resource indicator coupled with an associated L1-SL-RSRP/L1-SL-RSRQ/L1-SL-SINR/SL-CQI.

Upon receiving the beam report from the UE-A, the UE-B can use the beam report to select a reference RS corresponding to spatial TX filter at the UE-B and a spatial RX filter at the UE-A. As a result, a TX-RX beam pair is derived from the UE-B to the UE-A. By reciprocity (beam correspondence) the UE-B can select a SL-RX beam (spatial receive filter) corresponding to SL-TX beam (spatial transmit filter) at the UE-B, and the UE-A, when indicated a reference RS, can select a SL-TX beam (spatial transmit filter) at the UE-A corresponding to the SL-RX beam (spatial receive filter) at the UE-A associated with the reference RS. Hence, the TX-RX pair is derived for a SL transmission from the UE-A to the UE-B.

As aforementioned, the UE-B selects a SL TX beam for the UE-A and indicates the SL TX beam (for the UE-A) selection (step 1604) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS associated with a SL RX beam (spatial receive filter) at the UE-A and by reciprocity (beam correspondence), representing the selected SL TX beam to be used for SL transmission from the UE-A. In one example, the application of the indicated beam can be after beam application delay from the SL transmission conveying the beam indication or from the acknowledgment of the SL transmission conveying the beam indication.

In a variant, there is no beam indication, instead a beam is determined based on the beam measurement report as aforementioned in Example 3A of FIG. 9B.

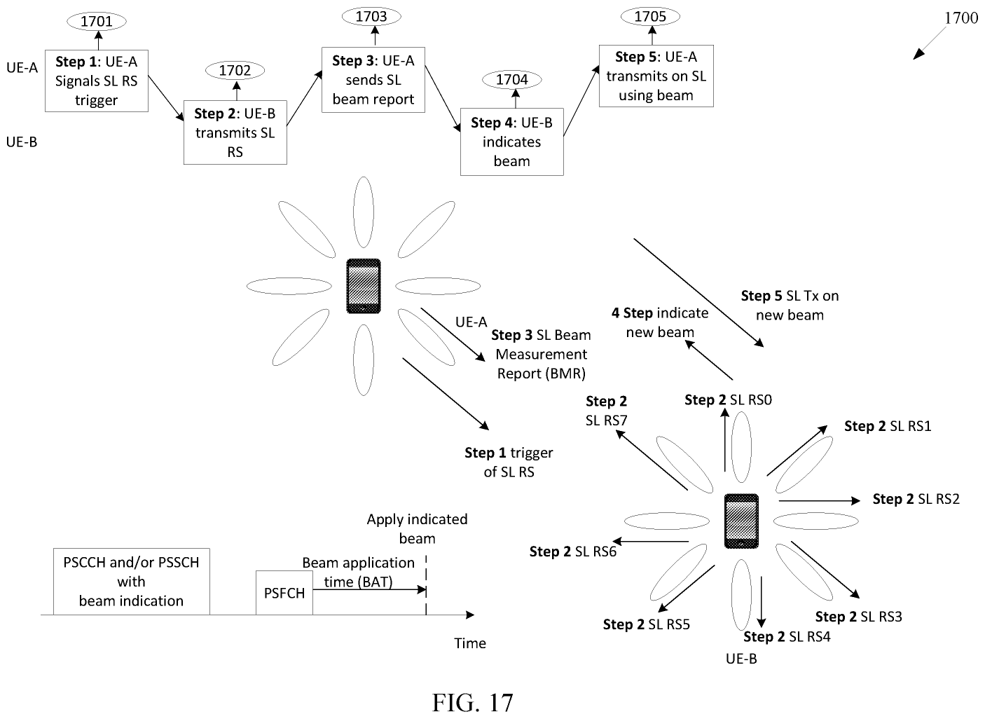

In one example, SL multi-beam operation starts with a UE-A signaling to a UE-B an aperiodic SL-RS (e.g., SL CSI-RS or SL SRS) trigger or request (step 1701). In FIG. 17, the trigger or request of SL RS is shown to be transmitted on one beam (spatial transmission filter) from the UE-A, in another example, the trigger or request of SL RS can be transmitted on multiple beams (or spatial transmission filters) from the UE-A. This trigger or request can be included in a SCI format (first stage SCI carried on PSCCH or second stage SCI carried on PSSCH and/or in a transmission on PSSCH and/or PSFCH and/or in a MAC CE and/or in an RRC message (e.g., PC5 RRC). In one example, the SL RS trigger can be jointly or separately coded with a SL beam measurement report trigger. Upon receiving and decoding the SL RS trigger or request (e.g., in an SCI Format) in step 1701, the UE-B transmits an aperiodic SL RS to the UE-A in step 1702. In FIG. 17, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL-RS transmitted by the UE-B (step 1702), the UE-A measures the AP-SL-RS (SL propagation channel from the UE-B to the UE-A) and, in turn, calculates and reports a “beam metric” that indicates a quality of a one or more UE-B SL TX beam hypothesis (step 1703). Examples of such beam reporting are SL RS resource indicator coupled with an associated L1-SL-RSRP/L1-SL-RSRQ/L1-SL-SINR/SL-CQI.

Upon receiving the beam report from the UE-A, the UE-B can use the beam report to select a reference RS corresponding to spatial TX filter at the UE-B and a spatial RX filter at the UE-A. As a result, a TX-RX beam pair is derived from the UE-B to the UE-A. By reciprocity (beam correspondence) the UE-B can select a SL-RX beam (spatial receive filter) corresponding to SL-TX beam (spatial transmit filter) at the UE-B, and the UE-A, when indicated a reference RS, can select a SL-TX beam (spatial transmit filter) at the UE-A corresponding to the SL-RX beam (spatial receive filter) at the UE-A associated with the reference RS. Hence, the TX-RX pair is derived for a SL transmission from the UE-A to the UE-B.

As aforementioned, the UE-B selects a SL TX beam for the UE-A and indicates the SL TX beam (for the UE-A) selection (step 1704) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS associated with a SL RX beam (spatial receive filter) at the UE-A and by reciprocity (beam correspondence), representing the selected SL TX beam to be used for SL transmission from the UE-A. In one example, the application of the indicated beam can be after beam application delay from the SL transmission conveying the beam indication or from the acknowledgment of the SL transmission conveying the beam indication.

In a variant, there is no beam indication, instead a beam is determined based on the beam measurement report as aforementioned in Example 3A of FIG. 9B.

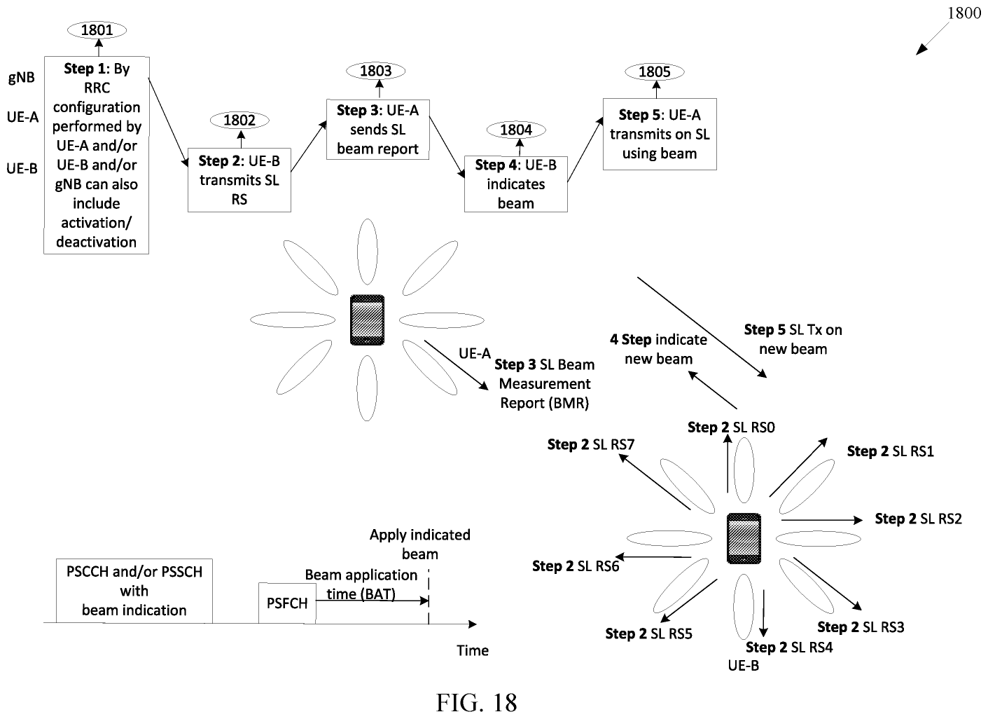

In one example, SL multi-beam operation starts with RRC configuration of SL RS resources for beam measurement. The configuration (step 1801) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1801, the UE-B transmits a periodic or semi-persistent SL RS to the UE-A in step 1802. In FIG. 18, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-B (step 1802), the UE-A measures the SL RS (SL propagation channel from the UE-B to the UE-A) and, in turn, calculates and reports a “beam metric” that indicates a quality of a one or more UE-B SL TX beam hypothesis (step 1903). Examples of such beam reporting are SL RS resource indicator coupled with an associated L1-SL-RSRP/L1-SL-RSRQ/L1-SL-SINR/SL-CQI.

Upon receiving the beam report from the UE-A, the UE-B can use the beam report to select a reference RS corresponding to spatial TX filter at the UE-B and a spatial RX filter at the UE-A. As a result, a TX-RX beam pair is derived from the UE-B to the UE-A. By reciprocity (beam correspondence) the UE-B can select a SL-RX beam (spatial receive filter) corresponding to SL-TX beam (spatial transmit filter) at the UE-B, and the UE-A, when indicated a reference RS, can select a SL-TX beam (spatial transmit filter) at the UE-A corresponding to the SL-RX beam (spatial receive filter) at the UE-A associated with the reference RS. Hence, the TX-RX pair is derived for a SL transmission from the UE-A to the UE-B.

As aforementioned, the UE-B selects a SL TX beam for the UE-A and indicates the SL TX beam (for the UE-A) selection (step 1804) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS associated with a SL RX beam (spatial receive filter) at the UE-A and by reciprocity (beam correspondence), representing the selected SL TX beam to be used for SL transmission from the UE-A. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to a UE-B, the UE-B further signals or indicates the reference RS (or selected beam) to the UE-A.

In a variant, there is no beam indication, instead a beam is determined based on the beam measurement report as aforementioned in Example 3A of FIG. 9B.

For Example 3 of FIG. 9A, as described above, a UE-A selects its SL RX beam using an index of a reference RS, such as a SL-CSI-RS or SL-SRS, that is provided via beam indication field, for example in a SCI format (first stage SCI carried on PSCCH or second stage SCI carried on PSSCH). In this case, SL RS resources transmitted by a UE-B are configured to the UE-A and the UE-B as the reference RS resources and by reciprocity, (beam correspondence), the UE-A can determine a spatial TX filter corresponding to the spatial RX filter associated with the reference RS indicated by the UE-B. Similarly, the UE-B selects a spatial RX filter corresponding to the spatial TX filter associated with the reference RS at the UE-B.

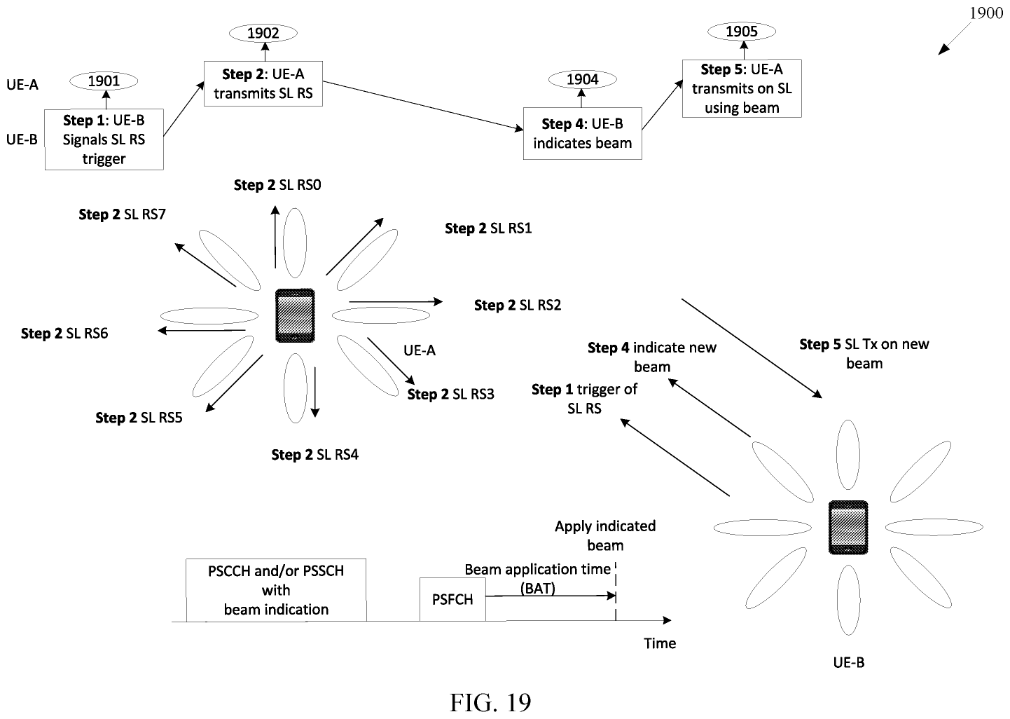

In one example, SL multi-beam operation starts with a UE-B signaling to a UE-A an aperiodic SL RS (e.g., SL CSI-RS or SL SRS) trigger or request (step 1901). In one example, the trigger or request for the SL RS includes a slot offset for a slot for the SL RS transmission. In FIG. 19, the trigger or request of SL RS is shown to be transmitted on one beam (spatial transmission filter) from the UE-B, in another example, the trigger or request of SL RS can be transmitted on multiple beams (or spatial transmission filters) from the UE-B. This trigger or request can be included in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). Upon receiving and decoding the SL RS trigger or request (e.g., in an SCI Format) in step 1901, the UE-A transmits an aperiodic SL RS to the UE-B in step 1902. Each RS reference can be associated with a SL TX beam from the UE-A. In FIG. 19, the SL RS is shown to be transmitted on multiple beams (spatial transmission filters) from the UE-A. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 1902), the UE-B measures the SL propagation channel from the UE-A to the UE-B and selects a SL TX beam for the UE-A. In this example, there is no reporting of beam measurements as the UE-A already has the measurements.

The UE-B can then indicate the SL TX beam (from the UE-A) selection (step 1904) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. The UE-A selects its SL TX beam and performs SL transmission, such as a PSSCH/PSCCH transmission, using the SL TX beam associated with the reference RS (step 1905). In one example, the application of the indicated beam can be after beam application delay from the SL transmission conveying the beam indication or from the acknowledgment of the SL transmission conveying the beam indication.

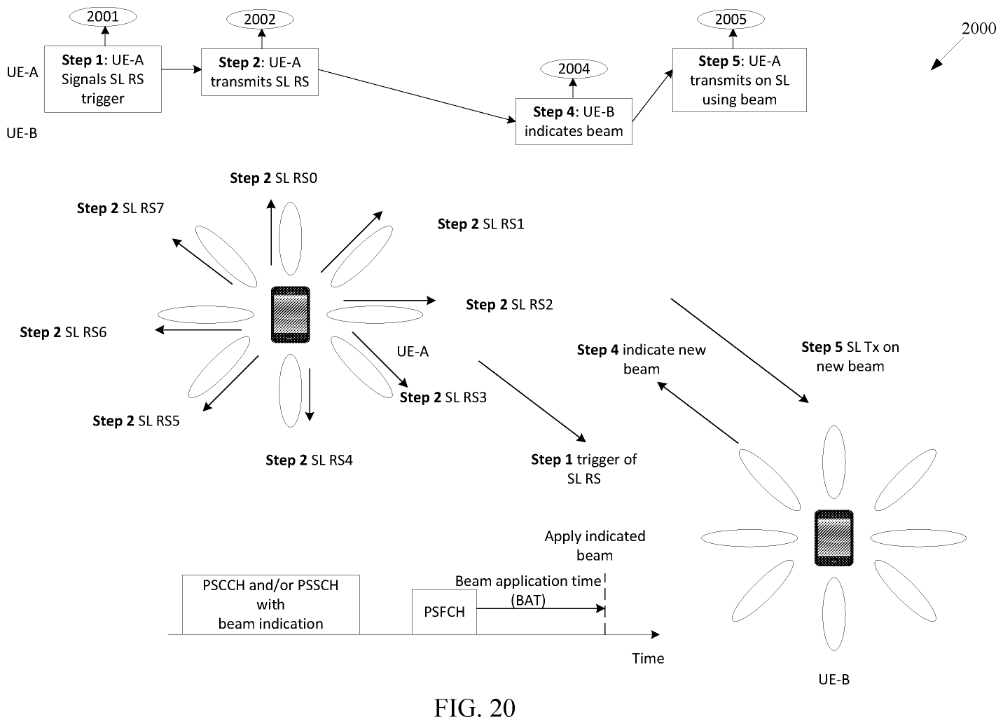

In one example, SL multi-beam operation starts with a UE-A signaling to a UE-B an aperiodic SL-RS (e.g., SL CSI-RS or SL SRS) trigger or indication (step 2001). In FIG. 20, the trigger or indication of SL RS is shown to be transmitted on one beam (spatial transmission filter) from the UE-A, in another example, the trigger or indication of SL RS can be transmitted on multiple beams (or spatial transmission filter) from the UE-A. This trigger or indication can be included in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In one example the trigger or indication can indicate transmission of SL RS in a same (zero time offset) or in a later slot/sub-frame (>0 time offset). The UE-A transmits an aperiodic SL RS to the UE-B in step 2002. Each RS reference can be associated with a SL TX beam from the UE-A. In FIG. 20, the SL RS is shown to be transmitted on multiple beams (spatial transmission filters) from the UE-A. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 2002), the UE-B measures the SL propagation channel from the UE-A to the UE-B and selects a SL TX beam for the UE-A. In this example, there is no reporting of beam measurements as the UE-A already has the measurements.

The UE-B can then indicate the SL TX beam (from the UE-A) selection (step 2004) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. The UE-A selects its SL TX beam and performs SL transmission, such as a PSSCH/PSCCH transmission, using the SL TX beam associated with the reference RS (step 2005). In one example, the application of the indicated beam can be after beam application delay from the SL transmission conveying the beam indication or from the acknowledgment of the SL transmission conveying the beam indication.

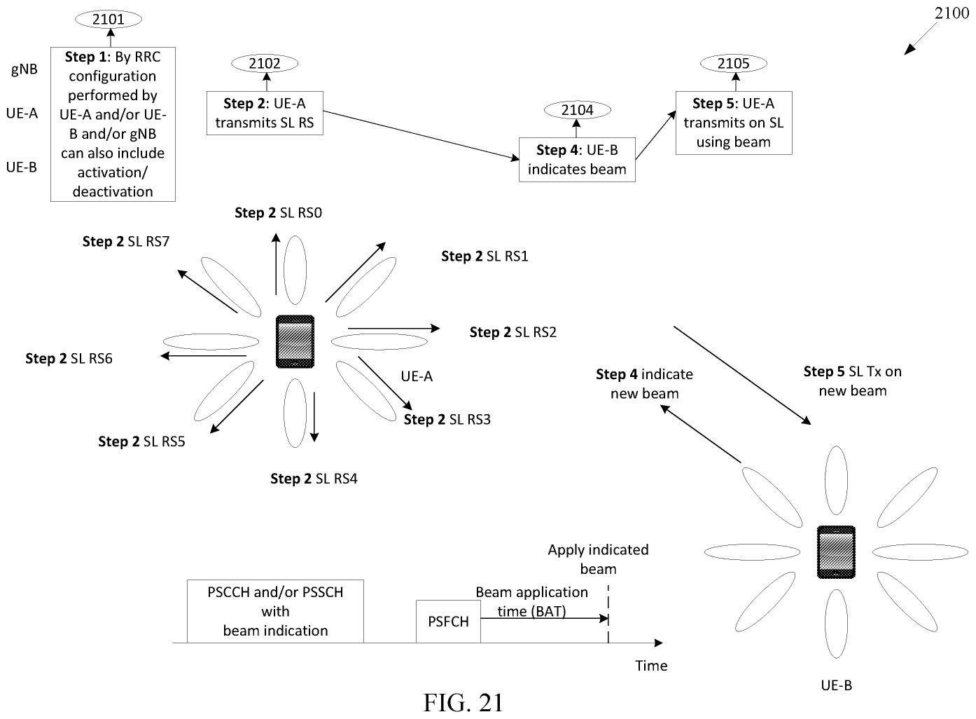

In one example, SL multi-beam operation starts with RRC configuration of SL RS resources for beam measurement. The configuration (step 2101) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 2101, the UE-A transmits a periodic or semi-persistent SL RS to the UE-B in step 2102. Each RS reference can be associated with a SL TX beam from the UE-A. In FIG. 21, the SL RS is shown to be transmitted on multiple beams (spatial transmission filters) from the UE-A. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 2102), the UE-B measures the SL propagation channel from the UE-A to the UE-B and selects a SL TX beam for the UE-A. In this example, there is no reporting of beam measurements as the UE-A already has the measurements.

The UE-B can then indicate the SL TX beam (from the UE-A) selection (step 2104) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. The UE-A selects its SL TX beam and performs SL transmission, such as a PSSCH/PSCCH transmission, using the SL TX beam associated with the reference RS (step 2105). In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to a UE-A and a UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

For Example, 4 of FIG. 9A, as described above, a UE-A selects its SL TX beam using an index of a reference RS, such as a SL-CSI-RS or SL-SRS, that is provided via beam indication field, for example in a SCI format (first stage SCI carried on PSCCH or second stage SCI carried on PSSCH) from a UE-B. In this case, SL RS resources transmitted by the UE-A are configured to the UE-A and the UE-B as the reference RS resources. The UE-B measures the reference RS transmitted from the UE-A to determine the SL RX beam (spatial receive filter) at the UE-B and indicate the reference RS to the UE-A.

As illustrated in FIG. 9A, multi-beam operation includes the following example steps.

In one example of step, configuration, activation/deactivation and/or triggering of reference RS is provided. This can be performed by a UE-A and/or a UE-B and/or a gNB/network (when the UE-A and/or the UE-B) is in coverage of the network. In one example, the UE operates in mode 1 resource allocation and SL resource used for the transmission of the trigger or indication or request signal is allocated by network. In a further example, when the UE operates in mode 1 resource allocation, the UE may send a signal (e.g., on PUCCH or PUSCH) to the network when the UE (e.g., the UE-A and/or the UE-B) determines that a new beam may be used for SL transmission, then the network can allocate resources for the transmission of the trigger or indication or request.

In one example of step, transmission of reference RS is provided. This can be performed by the UE-A (examples 1 and 4 of FIG. 9A), or by the UE-B (examples 2 and 3 of FIG. 9A). In one example, the UE operates in mode 1 resource allocation and SL resource used for the transmission of the reference RS is allocated by network. In a further example, when the UE operates in mode 1 resource allocation, the UE may send a signal (e.g., on PUCCH or PUSCH) to the network when the UE (e.g., the UE-A and/or the UE-B) determines that a new beam may be used for SL transmission, then the network can allocate resources for the transmission of the reference RS. In one example, the trigger or indication signal and the reference RS are included in the same SL transmission. In another example, the trigger or indication or request signal and the reference RS are included different SL transmissions. In one example, the UE sending a trigger or indication or request signal for transmission of reference RS may indicate resources to be used for the transmission of the reference RS.

In one example of step, reference RS measurement and beam reporting if applicable is provided. The reference RS is measured by an entity different from the entity transmitting the reference RS. The reference RS can be measured by the UE-A (examples 2 and 3 of FIG. 9A) or by the UE-B (examples 1 and 4 of FIG. 9A). The beam report can be sent by one entity to another entity that determines the beam. Beam report can be sent by the UE-B (example 1 of FIG. 9A), or by the UE-A (example 3 of FIG. 9A). If the UE determining the beam is the same as the UE measuring the reference RS, there is no beam report (example 2 and 4 of FIG. 9A).

In one example, the UE operates in mode 1 resource allocation and SL resource used for the transmission of the SL beam measurement report is allocated by network. In a further example, when the UE operates in mode 1 resource allocation, the UE may send a signal (e.g., on PUCCH or PUSCH) to the network when the UE (e.g., the UE-A and/or the UE-B) determines that a new beam may be used for SL transmission, then the network can allocate resources for the transmission of the SL beam measurement report to the UE reporting SL beam measurements. In another example, when the UE operates in mode 1 resource allocation, the UE may send a signal (e.g., on PUCCH or PUSCH) to the network when the UE (e.g., the UE-A and/or the UE-B) has or is about to have a beam measurement report to send to another UE, then the network can allocate resources for the transmission of the SL beam measurement report to the UE reporting SL beam measurements. In one example, the UE sending a trigger or indication or request signal for transmission of reference RS may indicate resources to be used for the transmission of the SL beam measurement report. In one example, the UE sending a reference RS may indicate resources to be used for the transmission of the SL beam measurement report.

In one example of step, beam selection and beam indication are provided. The beam indication can be sent to the UE-A (examples 1 and 2 of FIG. 9A) or by UE (examples 3 and 4 of FIG. 9A). In one example, the UE operates in mode 1 resource allocation and SL resource used for the transmission of the SL beam indication is allocated by network. In a further example, when the UE operates in mode 1 resource allocation, the UE may send a signal (e.g., on PUCCH or PUSCH) to the network when the UE (e.g., the UE-A and/or the UE-B) determines that a new beam may be used for SL transmission, then the network can allocate resources for the transmission of SL beam indication to the UE that transmits the SL beam indication. In another example, when the UE operates in mode 1 resource allocation, the UE may send a signal (e.g., on PUCCH or PUSCH) to the network when the UE (e.g., the UE-A and/or the UE-B) indicates or is about to indicate a SL beam to another UE, then the network can allocate resources for the transmission of the SL beam indication to the UE that transmits the SL beam indication.

In one example, the UE sending a trigger or indication or request signal for transmission of reference RS may indicate resources to be used for the transmission of the SL beam indication. In one example, the UE sending a reference RS may indicate resources to be used for the transmission of the SL beam indication. In one example, the UE sending a SL beam measurement report may indicate resources to be used for the transmission of the SL beam indication. In one example, the SL beam indication is included with other SL data transmission, wherein the SL beam indication is not applied to the included SL data. In one example, the SL beam indication is included with other SL data transmission, wherein the SL beam indication is applied to the included SL data.

In one example of step, transmission and reception of the SL transmission using the selected beam are provided.

In one example, the beam management procedure can be triggered or started or initiated by the UE transmitting the SL data. In another, example the beam management procedure can be triggered or started or initiated by the UE receiving the SL data.

In one example, for a pair of UEs, e.g., a UE-A and a UE-B, when the UE-A transmits on the SL to the UE-B and the UE-B transmits on the SL to the UE-A, a same beam pair can be found for SL transmission from the UE-A to the UE-B and for SL transmission from the UE-B to the UE-A, in this example a same reference signal ID or index can be used to identify such beam pair, a single beam management procedure can be triggered to find such beam pair, this can apply to the case of beam reciprocity or beam correspondence at the UE-A and the UE-B.

In another example, for a pair of UEs, e.g., a the UE-A and a UE-B, when the UE-A transmits on the SL to the UE-B and the UE-B transmits on the SL to the UE-A, a different beam pairs can be found for SL transmission from the UE-A to the UE-B and for SL transmission from the UE-B to the UE-A, in this example a first reference signal ID or index can be used to identify a first beam pair for SL transmission from the UE-A to the UE-B and a second, a second reference signal ID or index can be used to identify a second beam pair for SL transmission from the UE-A to the UE-B. A first beam management procedure can be triggered to find the first reference signal ID (or first beam pair), a second beam management procedure can be triggered to find the second reference signal ID (or second beam pair). This can apply to the case of no beam reciprocity, or no beam correspondence at the UE-A and/or the UE-B, or to the case of beam reciprocity or beam correspondence at the UE-A and the UE-B.

It is noted that that in addition to the above, a third UE, e.g., a UE-C can be involved in the beam management procedure. For example, a UE-C can configure, activate/deactivate and/or trigger the beam management procedure and the transmission of reference signals for channel sounding for beam management. The third UE can also receive the beam measurement report and make a decision on which beams to use and send this decision to the UE-A and/or the UE-B.

In one example, a UE (e.g., a UE-A and/or a UE-B) may send a signal (e.g., on PUCCH or PUSCH) to the gNB/network when the UE (e.g., the UE-A and/or the UE-B) determines that a new beam may be used for SL transmission. Alternatively, a gNB may determine that a new beam may be used for SL transmission from the UE-A to the UE-B. SL multi-beam operation starts or continues with the gNB/network signaling to the UE-A and/or the UE-B an aperiodic SL RS (e.g., SL CSI-RS or SL SRS) trigger or indication or request (step 2201). In one example, the trigger/indication/request can include a slot offset for transmission of the SL RS. In one example, the trigger/indication/request of the SL RS is transmitted from the gNB/network to the UE-A and the UE-B.

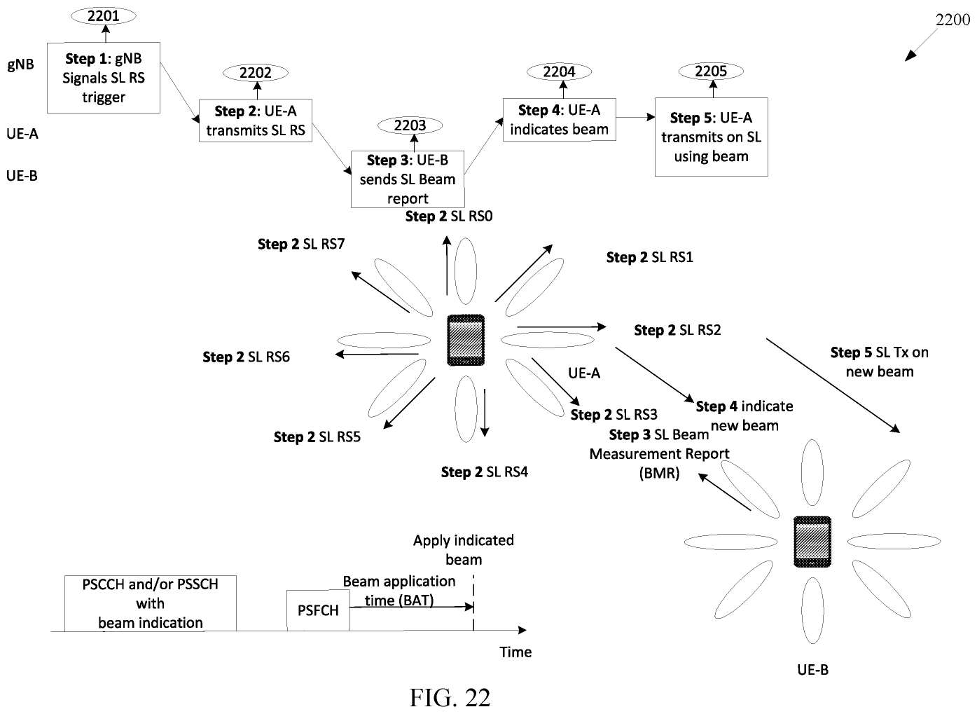

In another example, the trigger/indication/request of the SL RS is transmitted from the gNB/network to the UE-A, the UE-A can then send the trigger/indication to the UE-B on the SL interface before transmitting the SL RS. In another example, the trigger/indication/request of the SL RS is transmitted from the gNB/network to the UE-B, the UE-B can then send the trigger/request to the UE-A on the SL interface for the UE-A to transmit the SL RS. Upon receiving the SL RS trigger or indication or request in step 2201, the UE-A transmits an aperiodic SL RS to the UE-B in step 2202. In FIG. 22, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 2202), the UE-B measures the AP-SL-RS and calculates and reports a “beam metric” that indicates a quality of one or more UE-A SL TX beam hypothesis (step 2203). Examples of such beam reporting are a SL RS resource indicator coupled with an associated L1-SL-RSRP/L1-SL-RSRQ/L1-SL-SINR/SL-CQI.

Upon receiving the beam report from the UE-B, the UE-A can use the beam report to select a SL RX beam for the UE-B to receive on and indicate the SL RX beam (for the UE-B) selection (step 2204) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. A UE-B selects its SL RX beam and performs SL reception, such as a PSSCH/PSCCH reception, using the SL RX beam associated with the reference RS (step 2205). In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

In a variant, there is no beam indication, instead a beam is determined based on the beam measurement report as aforementioned in Example 1A of FIG. 9B.

In one example, SL multi-beam operation starts with RRC configuration of SL RS resources for beam measurement. The configuration (step 1201) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1201, the UE-A transmits a periodic or semi-persistent SL RS to the UE-B in step 1202. In FIG. 12, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-A (step 1202), the UE-B measures the SL-RS and calculates and reports a “beam metric” that indicates a quality of one or more the UE-A SL TX beam hypothesis (step 1203). Examples of such beam reporting are a SL RS resource indicator coupled with an associated L1-SL-RSRP/L1-SL-RSRQ/L1-SL-SINR/SL-CQI.

Upon receiving the beam report from the UE-B, the UE-A can use the beam report to select a SL RX beam for the UE-B to receive on and indicate the SL RX beam (for the UE-B) selection (step 1204) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. A UE-B selects its SL RX beam and performs SL reception, such as a PSSCH/PSCCH reception, using the SL RX beam associated with the reference RS (step 1205). In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

In a variant, there is no beam indication, instead a beam is determined based on the beam measurement report as aforementioned in Example 1A of FIG. 9B.

For Example 1 of FIG. 9A, as described above, a UE-B selects its SL RX beam using an index of a reference RS, such as a SL-CSI-RS or SL-SRS, that is provided via beam indication field, for example in a SCI format (first stage SCI carried on PSCCH or second stage SCI carried on PSSCH) from the UE-B. In this case, SL RS resources transmitted by a UE-A are configured to the UE-A and the UE-B as the reference RS resources and can be linked to (associated with) a “beam metric” reporting such as L1-SL-RSRP/L1-SL-RSRQ/L1-SL-SINR/SL-CQI. The UE-A measures the reference RS transmitted from the UE-B to determine the SL RX beam (spatial receive filter) at UE-A and indicate the reference RS to the UE-B.

In one example, a UE (e.g., a UE-A and/or a UE-B) may send a signal (e.g., on PUCCH or PUSCH) to the gNB/network when the UE (e.g., the UE-A and/or the UE-B) determines that a new beam may be used for SL transmission. Alternatively, a gNB may determine that a new beam may be used for SL transmission from the UE-A to the UE-B. SL multi-beam operation starts or continues with the gNB/network signaling to the UE-A and/or the UE-B an aperiodic SL RS (e.g., SL CSI-RS or SL SRS) trigger or indication or request (step 2301). In one example, the trigger/indication/request can include a slot offset for transmission of the SL RS. In one example, the trigger/indication/request of the SL RS is transmitted from the gNB/network to the UE-A and the UE-B.

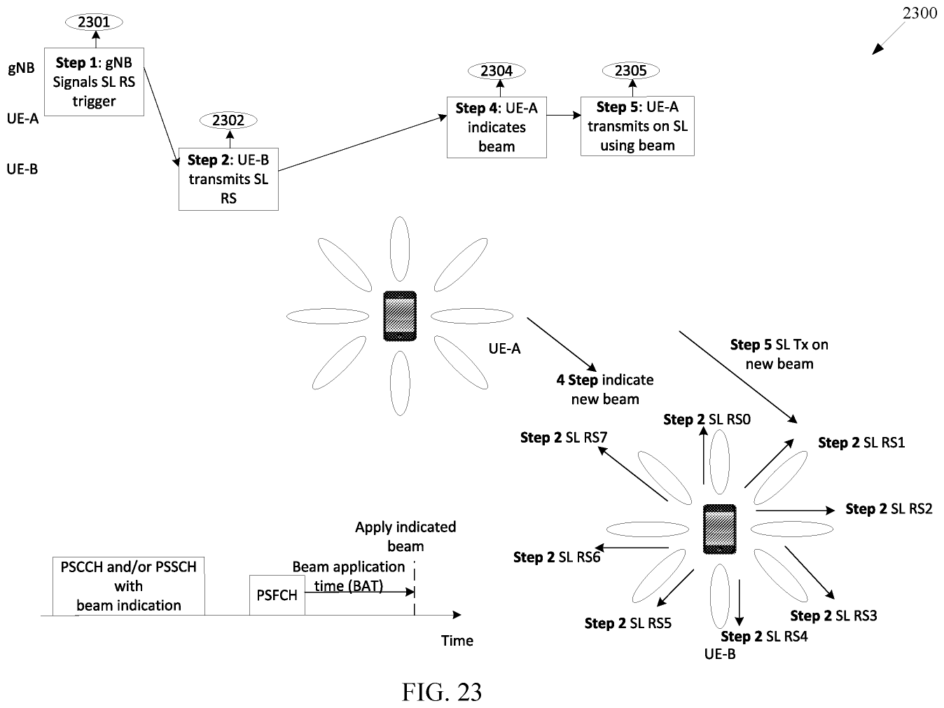

In another example, the trigger/indication/request of the SL RS is transmitted from the gNB/network to the UE-A, the UE-A can then send the trigger/request to a UE-B on the SL interface for the UE-B to transmit the SL RS. In another example, the trigger/indication/request of the SL RS is transmitted from the gNB/network to the UE-B, the UE-B can then send the trigger/indication to the UE-A on the SL interface before transmitting the SL RS. Upon receiving the SL RS trigger or indication or request in step 2301, the UE-B transmits an aperiodic SL RS to the UE-A in step 2302. Each RS reference can be associated with a SL TX beam from the UE-B. In FIG. 23, the SL RS is shown to be transmitted on multiple beams (spatial transmission filters) from the UE-B. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-B (step 2302), the UE-A measures the SL propagation channel from the UE-B to the UE-A. In this example, there is no reporting of beam measurements as the UE-A already has the measurements. The UE-A selects a SL RX beam at the UE-A for every SL TX beam from the UE-B that corresponds to a reference RS. As a result, a TX-RX beam pair is derived from the UE-B to the UE-A. By reciprocity (beam correspondence) the UE-A can select a SL-TX beam corresponding to SL-RX beam at the UE-A, and the UE-B, when indicated a reference signal, can select a SL-RX beam at the UE-B corresponding to the SL-TX beam at the UE-B associated with the reference signal. Hence, the TX-RX pair is derived for a SL transmission from the UE-A to the UE-B.

As aforementioned, the UE-A can use the SL measurement to select a SL RX beam for the UE-B to receive on and indicate the SL RX beam (for the UE-B) selection (step 2304) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. The UE-B selects its SL RX beam and performs SL reception, such as a PSSCH/PSCCH reception, using the SL RX beam associated with the reference RS (step 2305) as aforementioned. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

In one example, SL multi-beam operation starts with RRC configuration of SL RS resources for beam measurement. The configuration (step 1501) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1501, the UE-B transmits a periodic or semi-persistent SL RS to the UE-A in step 1502. Each RS reference can be associated with a SL TX beam from the UE-B. In FIG. 15, the SL RS is shown to be transmitted on multiple beams (spatial transmission filters) from the UE-B. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-B (step 1502), the UE-A measures the SL propagation channel from the UE-B to the UE-A. In this example, there is no reporting of beam measurements as the UE-A already has the measurements. The UE-A selects a SL RX beam at the UE-A for every SL TX beam from the UE-B that corresponds to a reference RS. As a result, a TX-RX beam pair is derived from the UE-B to the UE-A. By reciprocity (beam correspondence) the UE-A can select a SL-TX beam corresponding to SL-RX beam at the UE-A, and the UE-B, when indicated a reference signal, can select a SL-RX beam at the UE-B corresponding to the SL-TX beam at the UE-B associated with the reference signal. Hence, the TX-RX pair is derived for a SL transmission from the UE-A to the UE-B.

As aforementioned, the UE-A can use the SL measurement to select a SL RX beam for the UE-B to receive on and indicate the SL RX beam (for the UE-B) selection (step 1504) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. In one example, the beam indication is included in a same SL transmission as SL data. In another example, the beam indication is included in a separate SL transmission from SL data. The UE-B selects its SL RX beam and performs SL reception, such as a PSSCH/PSCCH reception, using the SL RX beam associated with the reference RS (step 1505) as aforementioned. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

For Example 2 of FIG. 9A, as described above, a UE-B selects its SL RX beam using an index of a reference RS, such as a SL-CSI-RS or SL-SRS, that is provided via beam indication field, for example in a SCI format (first stage SCI carried on PSCCH or second stage SCI carried on PSSCH). In this case, SL RS resources transmitted by the UE-B are configured to a UE-A and the UE-B as the reference RS resources and by reciprocity, (beam correspondence), the UE-B can determine a spatial RX filter corresponding to the spatial TX filter associated with the reference RS indicated by a UE-A. Similarly, the UE-A selected a spatial TX filter corresponding to the spatial RX filter associated with the reference RS at the UE-A.

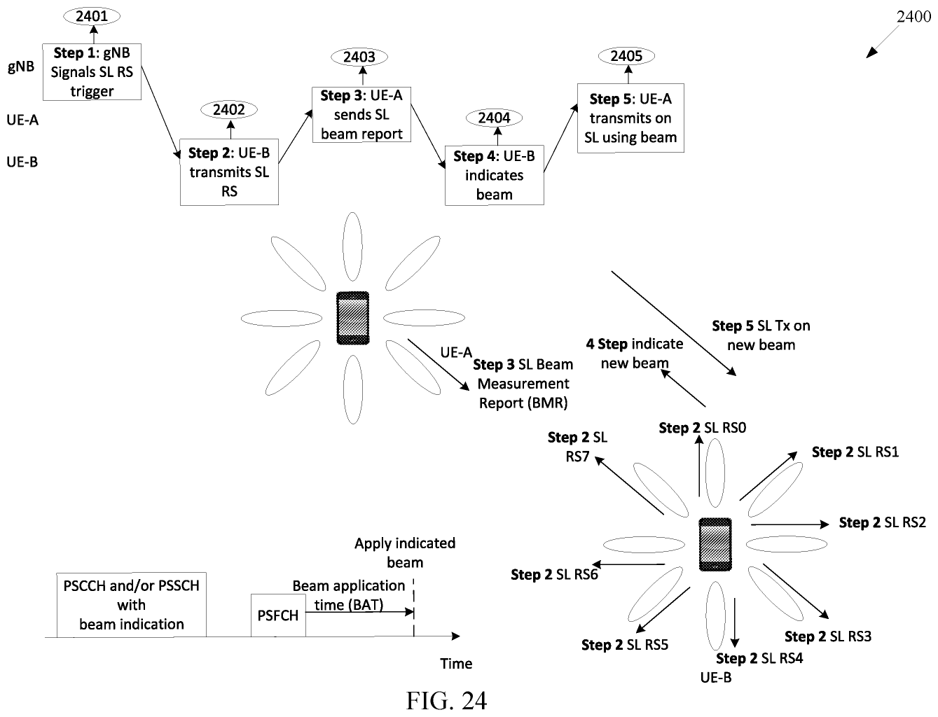

In one example, a UE (e.g., a UE-A and/or a UE-B) may send a signal (e.g., on PUCCH or PUSCH) to the gNB/network when the UE (e.g., the UE-A and/or the UE-B) determines that a new beam may be used for SL transmission. Alternatively, a gNB may determine that a new beam may be used for SL transmission from the UE-A to the UE-B. SL multi-beam operation starts or continues with a gNB/network signaling to the UE-A and/or the UE-B an aperiodic SL-RS (e.g., SL CSI-RS or SL SRS) trigger or indication or request (step 2401). In one example, the trigger/indication/request can include a slot offset for transmission of the SL RS. In one example, the trigger/indication/request of the SL RS is transmitted from the gNB/network to the UE-A and the UE-B. In another example, the trigger/indication/request of the SL RS is transmitted from the gNB/network to the UE-A, the UE-A can then send the trigger/request to the UE-B on the SL interface for the UE-B to transmit the SL RS. In another example, the trigger/indication/request of the SL RS is transmitted from the gNB/network to the UE-B, the UE-B can then send the trigger/indication to the UE-A on the SL interface before transmitting the SL RS. Upon receiving the SL RS trigger or indication or request in step 2401, the UE-B transmits an aperiodic SL RS to the UE-A in step 2402. In FIG. 24, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL-RS transmitted by the UE-B (step 2402), the UE-A measures the AP-SL-RS (SL propagation channel from the UE-B to the UE-A) and, in turn, calculates and reports a “beam metric” that indicates a quality of one or more UE-B SL TX beam hypothesis (step 2403). Examples of such beam reporting are SL RS resource indicator coupled with an associated L1-SL-RSRP/L1-SL-RSRQ/L1-SL-SINR/SL-CQI.

Upon receiving the beam report from the UE-A, the UE-B can use the beam report to select a reference RS corresponding to spatial TX filter at the UE-B and a spatial RX filter at the UE-A. As a result, a TX-RX beam pair is derived from the UE-B to the UE-A. By reciprocity (beam correspondence) the UE-B can select a SL-RX beam (spatial receive filter) corresponding to SL-TX beam (spatial transmit filter) at the UE-B, and the UE-A, when indicated a reference RS, can select a SL-TX beam (spatial transmit filter) at the UE-A corresponding to the SL-RX beam (spatial receive filter) at the UE-A associated with the reference RS. Hence, the TX-RX pair is derived for a SL transmission from the UE-A to the UE-B.

As aforementioned, the UE-B selects a SL TX beam for the UE-A and indicates the SL TX beam (for the UE-A) selection (step 2404) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS associated with a SL RX beam (spatial receive filter) at the UE-A and by reciprocity (beam correspondence), representing the selected SL TX beam to be used for SL transmission from the UE-A. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

In a variant, there is no beam indication, instead a beam is determined based on the beam measurement report as aforementioned in Example 3A of FIG. 9B.

In one example, SL multi-beam operation starts with RRC configuration of SL RS resources for beam measurement. The configuration (step 1801) of SL RS (e.g., SL CSI-RS or SL-SRS or S-SSB) resources can be performed by a UE-A and/or a UE-B and/or a gNB/network. In one example, the configuration of the SL RS includes configuration of time domain parameters such as a periodicity and/or a slot offset within the periodicity. In another example, the SL RS transmission can be activated or deactivated, wherein the activation or deactivation can be by MAC CE signaling and/or L1 control signaling (e.g., DCI or SCI (first stage SCI carried on PSCCH or second stage SCI carried on PSSCH) or PSFCH). The activation or deactivation of SL RS can be performed by the UE-A and/or the UE-B and/or a gNB/network. In one example, the entity configuring the SL RS is the same as the entity activating or deactivating the SL RS. In another example, the entity configuring the SL RS can be different from the entity activating or deactivating the SL RS. Upon configuring or activating the SL RS in step 1801, the UE-B transmits a periodic or semi-persistent SL RS to the UE-A in step 1802. In FIG. 18, the SL RS is shown to be transmitted on multiple beams (spatial transmission filters). In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the SL RS transmitted by the UE-B (step 1802), the UE-A measures the SL RS (SL propagation channel from the UE-B to the UE-A) and, in turn, calculates and reports a “beam metric” that indicates a quality of a one or more UE-B SL TX beam hypothesis (step 1803). Examples of such beam reporting are SL RS resource indicator coupled with an associated L1-SL-RSRP/L1-SL-RSRQ/L1-SL-SINR/SL-CQI.

Upon receiving the beam report from the UE-A, the UE-B can use the beam report to select a reference RS corresponding to spatial TX filter at the UE-B and a spatial RX filter at the UE-A. As a result, a TX-RX beam pair is derived from the UE-B to the UE-A. By reciprocity (beam correspondence) the UE-B can select a SL-RX beam (spatial receive filter) corresponding to SL-TX beam (spatial transmit filter) at the UE-B, and the UE-A, when indicated a reference RS, can select a SL-TX beam (spatial transmit filter) at the UE-A corresponding to the SL-RX beam (spatial receive filter) at the UE-A associated with the reference RS. Hence, the TX-RX pair is derived for a SL transmission from the UE-A to the UE-B.

As aforementioned, the UE-B selects a SL TX beam for the UE-A and indicates the SL TX beam (for the UE-A) selection (step 1804) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS associated with a SL RX beam (spatial receive filter) at the UE-A and by reciprocity (beam correspondence), representing the selected SL TX beam to be used for SL transmission from the UE-A. In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to a UE-B, the UE-B further signals or indicates the reference RS (or selected beam) to the UE-A.

In a variant, there is no beam indication, instead a beam is determined based on the beam measurement report as aforementioned in Example 3A of FIG. 9B.

For Example 3 of FIG. 9A, as described above, a UE-A selects its SL RX beam using an index of a reference RS, such as a SL-CSI-RS or SL-SRS, that is provided via beam indication field, for example in a SCI format (first stage SCI carried on PSCCH or second stage SCI carried on PSSCH). In this case, SL RS resources transmitted by a UE-B are configured to the UE-A and the UE-B as the reference RS resources and by reciprocity, (beam correspondence), the UE-A can determine a spatial TX filter corresponding to the spatial RX filter associated with the reference RS indicated by the UE-B. Similarly, the UE-B selects a spatial RX filter corresponding to the spatial TX filter associated with the reference RS at the UE-B.

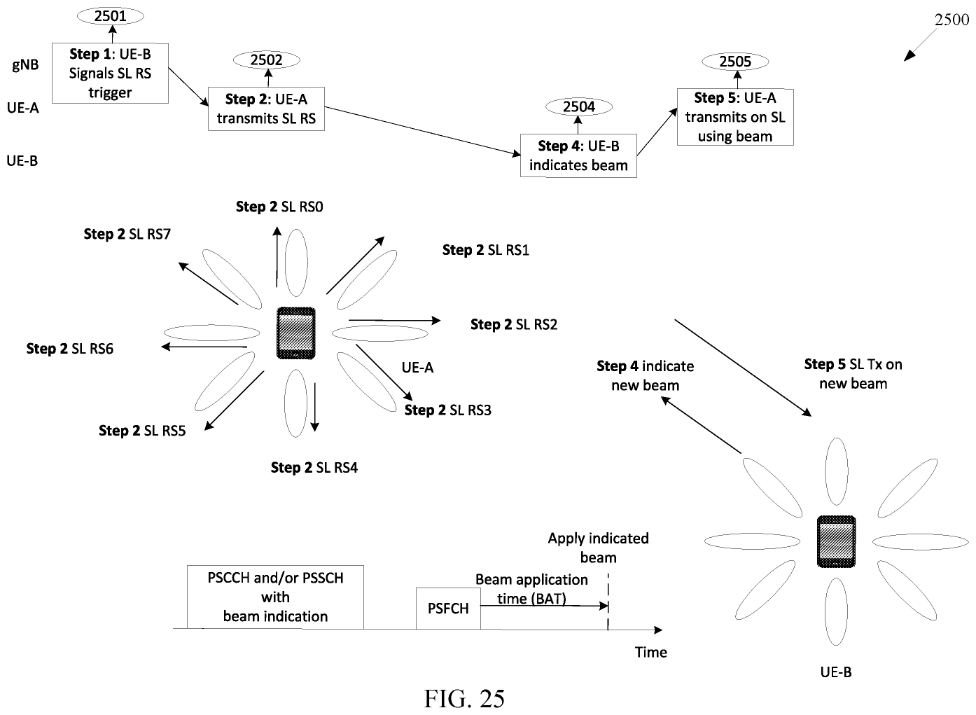

In one example, a UE (e.g., a UE-A and/or a UE-B) may send a signal (e.g., on PUCCH or PUSCH) to the gNB/network when the UE (e.g., the UE-A and/or the UE-B) determines that a new beam may be used for SL transmission. Alternatively, a gNB may determine that a new beam may be used for SL transmission from the UE-A to the UE-B. SL multi-beam operation starts or continues with the gNB/network signaling to the UE-A an aperiodic SL RS (e.g., SL CSI-RS or SL SRS) trigger or indication or request (step 2501). In one example, the trigger/indication/request can include a slot offset for transmission of the SL RS. In one example, the trigger/indication/request of the SL RS is transmitted from the gNB/network to the UE-A and the UE-B. In another example, the trigger/indication/request of the SL RS is transmitted from the gNB/network to the UE-A, the UE-A can then send the trigger/indication to the UE-B on the SL interface before transmitting the SL RS. In another example, the trigger/indication/request of the SL RS is transmitted from the gNB/network to the UE-B, the UE-B can then send the trigger/request to the UE-A on the SL interface for the UE-A to transmit the SL RS. Upon receiving the SL RS trigger or indication or request in step 2501, the UE-A transmits an aperiodic SL RS to the UE-B in step 2502. Each RS reference can be associated with a SL TX beam from the UE-A. In FIG. 25, the SL RS is shown to be transmitted on multiple beams (spatial transmission filters) from the UE-A. In one example, a single beam is used in a time period (e.g., determined by symbol(s) and/or slot(s)), different beams are transmitted sequentially over multiple time periods. In one example, multiple beams can be transmitted in a time period (e.g., determined by symbol(s) and/or slot(s)), e.g., transmissions on multiple beams can be FDMed, different beams are transmitted first in one-time period, and then over multiple time periods.

Upon receiving the AP-SL RS transmitted by the UE-A (step 2502), the UE-B measures the SL propagation channel from the UE-A to the UE-B and selects a SL TX beam for the UE-A. In this example, there is no reporting of beam measurements as the UE-A already has the measurements.

The UE-B can then indicate the SL TX beam (from the UE-A) selection (step 2504) using a field for beam indication in a SCI format (first stage SCI carried on PSCCH or second stage SCI carried on PSSCH) and/or in a transmission on PSSCH and/or PSFCH and/or in a MAC CE and/or in an RRC message (e.g., PC5 RRC). In this case, a value of the beam indication field in the SCI format and/or PSFCH and/or MAC CE and/or RRC message indicates a reference SL RS, representing the selected SL TX beam to be used for SL transmission from the UE-A. The UE-A selects its SL TX beam and performs SL transmission, such as a PSSCH/PSCCH transmission, using the SL TX beam associated with the reference RS (step 2505). In one example, the application of the indicated beam can be after beam application delay from the SL transmission conveying the beam indication or from the acknowledgment of the SL transmission conveying the beam indication.

In one example, a beam measurement report is provided from a UE-B (and/or a UE-A) to the gNB, the gNB can use the beam report to select a reference RS for determining a SL TX beam for the UE-A and a SL RX beam for the UE-B. In one example, the gNB signals or indicates the selected reference RS (or selected beam) to the UE-A and the UE-B. In one example, the gNB signals or indicates the selected reference RS (or selected beam) to the UE-A, the UE-A further signals or indicates the reference RS (or selected beam) to the UE-B. In one example, the gNB signals or indicates the reference RS (or selected beam) to the UE-B, the UE-B further signals or indicates the reference RS (or selected beam) to the UE-A.

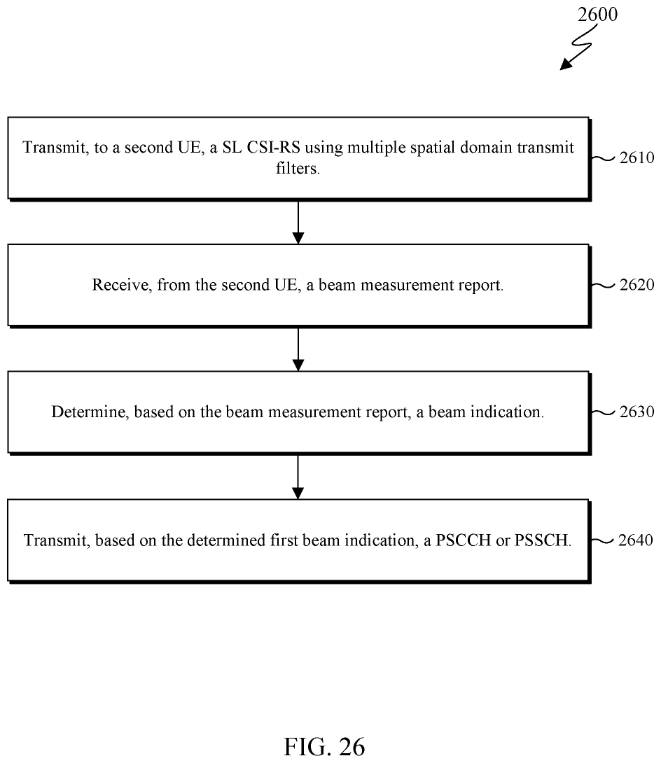

FIG. 26 illustrates an example method 2600 performed by a UE in a wireless communication system according to embodiments of the present disclosure. The method 2600 of FIG. 26 can be performed by any of the UEs 111-116 of FIG. 1, such as the UE 116 of FIG. 3, and a corresponding method can be performed by another of the UEs 111-116 of FIG. 1. The method 2600 is for illustration only and other embodiments can be used without departing from the scope of the present disclosure.

The method 2600 begins with the UE transmitting, to a second UE, a SL CSI-RS using multiple spatial domain transmit filters (2610). For example, in 2610, the UE may perform sensing and resource exclusion, and determine, based on the sensing and resource exclusion, a candidate resource for the SL CSI-RS. In various embodiments, the UE may also receive, from the second UE, a trigger to transmit the SL CSI-RS.

The UE then receives, from the second UE, a beam measurement report (2620). For example, in 2620, the beam measurement report may include M measurement pairs and each of the M measurement pairs includes a RS ID and a corresponding RSRP.

The UE then determines, based on the beam measurement report, a beam indication (2630). For example, in 2630, the UE may also transmit a first channel comprising the beam indication, receive a second channel comprising an acknowledgement for the first channel, and determine a time for application of the beam indication after an end time associated with the second channel. The UE then transmits, based on the determined beam indication, a PSCCH or PSSCH (2640).

In various embodiments, the UE may also perform a similar measurement and reporting based on a received RS. For example, the UE receive a SL CSI-RS from a third UE, measure and determine a second beam measurement report, and transmit the second beam measurement report to the third UE.

In various embodiments, the UE may also receive, from the second UE, a second PSCCH or PSSCH based on the beam indication. In various embodiments, the UE may also receive a second beam indication from the second UE, and receive, from the second UE, a second PSCCH or PSSCH based on the second beam indication.

In various embodiments, the UE may also transmit, to the second UE, a PSFCH using a spatial domain transmit filter associated with the PSCCH or PSSCH.

In various embodiments, the UE may also receive a first channel comprising a second beam indication, transmit a second channel comprising an acknowledgement for the first channel, and determine a time for application of the second beam indication after an end time associated with the second channel.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
transmit, to a second UE, a sidelink (SL) channel state information-reference signal (CSI-RS) using multiple spatial domain transmit filters, and
receive, from the second UE, a first beam measurement report; and
a processor operably coupled to the transceiver, the processor configured to determine, based on the first beam measurement report, a first beam indication,
wherein the transceiver is further configured to transmit, based on the determined first beam indication, a first physical SL control channel (PSCCH) or physical SL shared channel (PSSCH).

2. The UE of claim 1, wherein:
the transceiver is further configured to receive a SL CSI-RS from a third UE,
the processor is further configured to measure and determine a second beam measurement report, and
the transceiver is further configured to transmit the second beam measurement report to the third UE.

3. The UE of claim 1, wherein the transceiver is further configured to receive, from the second UE, a second PSCCH or PSSCH based on the first beam indication.

4. The UE of claim 1, wherein the transceiver is further configured to:
receive a second beam indication from the second UE, and
receive, from the second UE, a second PSCCH or PSSCH based on the second beam indication.

5. The UE of claim 1, wherein the transceiver is further configured to transmit, to the second UE, a physical SL feedback channel (PSFCH) using a spatial domain transmit filter associated with the first PSCCH or PSSCH.

6. The UE of claim 1, wherein:
the transceiver is further configured to:
transmit a first channel comprising the first beam indication, and
receive a second channel comprising an acknowledgement for the first channel; and
the processor is further configured to determine a time for application of the first beam indication after an end time associated with the second channel.

7. The UE of claim 1, wherein:
the transceiver is further configured to:
receive a first channel comprising a second beam indication, and
transmit a second channel comprising an acknowledgement for the first channel; and
the processor is further configured determine a time for application of the second beam indication after an end time associated with the second channel.

8. The UE of claim 1, wherein the processor is further configured to:
perform sensing and resource exclusion, and
determine, based on the sensing and resource exclusion, a candidate resource for the SL CSI-RS.

9. The UE of claim 1, wherein the transceiver is further configured to receive, from the second UE, a trigger to transmit the SL CSI-RS.

10. The UE of claim 1, wherein:
the first beam measurement report includes M measurement pairs, and
each of the M measurement pairs includes a reference signal (RS) identifier (ID) and a corresponding reference signal received power (RSRP).

11. A method of operating a user equipment (UE), the method comprising:
transmitting, to a second UE, a sidelink (SL) channel state information-reference signal (CSI-RS) using multiple spatial domain transmit filters;
receiving, from the second UE, a first beam measurement report;
determining, based on the first beam measurement report, a first beam indication; and
transmitting, based on the determined first beam indication, a first physical SL control channel (PSCCH) or physical SL shared channel (PSSCH).

12. The method of claim 11, further comprising:
receiving a SL CSI-RS from a third UE;
measuring and determining a second beam measurement report; and
transmitting the second beam measurement report to the third UE.

13. The method of claim 11, further comprising receiving, from the second UE, a second PSCCH or PSSCH based on the first beam indication.

14. The method of claim 11, further comprising:
receiving a second beam indication from the second UE; and
receiving, from the second UE, a second PSCCH or PSSCH based on the second beam indication.

15. The method of claim 11, further comprising transmitting, to the second UE, a physical SL feedback channel (PSFCH), using a spatial domain transmit filter associated with the first PSCCH or PSSCH.

16. The method of claim 11, further comprising:
transmitting a first channel comprising the first beam indication;
receiving a second channel comprising an acknowledgement for the first channel; and
determining a time for application of the first beam indication after an end time associated with the second channel.

17. The method of claim 11, further comprising:
receiving a first channel comprising a second beam indication;
transmitting a second channel comprising an acknowledgement for the first channel; and
determining a time for application of the second beam indication after an end time associated with the second channel.

18. The method of claim 11, further comprising:
performing sensing and resource exclusion; and
determining, based on the sensing and resource exclusion, a candidate resource for the SL CSI-RS.

19. The method of claim 11, further comprising receiving, from the second UE, a trigger to transmit the SL CSI-RS.

20. The method of claim 11, wherein,
the first beam measurement report includes M measurement pairs, and
each of the M measurement pairs includes a reference signal (RS) identifier (ID) and a corresponding reference signal received power (RSRP).
